(19) United States
(12) Patent Application Publication
(10) Pub. No.: US 2012/0278591 A1
(43) Pub. Date: Nov. 1, 2012

(54) CROSSBAR SWITCH MODULE HAVING DATA MOVEMENT INSTRUCTION PROCESSOR MODULE AND METHODS FOR IMPLEMENTING THE SAME

(75) Inventors: Scott HILKER, San Jose, CA (US); Kevin HURD, Ft. Collins, CO (US); Mark GIBSON, Timnath, CO (US); Jonathan CHOY, Sunnyvale, CA (US)

(73) Assignee: ADVANCED MICRO DEVICES, INC., Sunnyvale, CA (US)

(21) Appl. No.: 13/095,630

(22) Filed: Apr. 27, 2011

(51) Int. Cl. G06F 9/30

(52) U.S. Cl. 712/208; 712/E09.028

(57) ABSTRACT

A microprocessor is provided that has a datapath that is split into upper and lower portions. The microprocessor includes a centralized crossbar switch module having a single data movement module. The data movement module is capable of processing instructions that require operands to be exchanged between upper and lower 64-bit halves of the split architecture. The data movement module can access and process all instructions that require simultaneous access to the entire register contents of the upper and lower portions. The data movement module is configured to execute any one of a number of different instructions to perform data manipulation with respect to one or more “split-operands” (also referred to simply as “operands” herein). The data movement module can exchange data (bytes and/or bits) of operands for the upper and lower 64-bit halves so that bytes and/or bits of operands can be moved or rearranged to other positions during execution of a particular instruction. The data movement module can allow for various types of operand data movement/manipulation that may be required to implement instruction processing that may be required per various instructions, such as permute, pack, shuffle, vectored conditional move, extract, shift, rotate instructions, any other instruction in which operand data is manipulated, shifted, moved, re-ordered, shuffled or scrambled.

### TECHNICAL FIELD

Embodiments of the subject matter described herein relate generally to data processing, and to data processors that execute instructions. More particularly, embodiments of the subject matter relate to a crossbar switch module with a permute processor module that permutes operands and methods for implementing the same.

### BACKGROUND

A processing core can include multiple data processors that execute program instructions by performing various arithmetic operations, such as addition, multiplication, multiply-accumulate, and the like, which may include various numerical formats such as integer and floating point formats. The program instructions can include single-instruction multiple-data (SIMD) instructions and single-instruction single-data (SISD) instructions. A SIMD instruction (or vector instruction) is a program instruction that specifies that an arithmetic operation be performed independently a plurality of times on multiple pieces of data simultaneously, once for each of a plurality of operational operands retrieved as part of a single operand of the SIMD instruction. SIMD instructions have the ability of manipulating large vectors and matrices in minimal time. SIMD instructions allow easy parallelization of algorithms commonly involved in sound, image, and video processing. By contrast, a SISD instruction specifies that the arithmetic operation be performed a single time for an operational operand that corresponds to the operand of the SISD instruction.

A data processing device can include a coprocessor and one or more register files that store information (operands and results) and one or more functional (or execution) units that use operands to execute instructions and generate results. The computational performance of a data processing device can be determined by the speed at which the coprocessor device can execute program instructions. It is desirable to increase the speed at which the processor device can execute program instructions, such as SIMD instructions, SISD instructions, and the like. Factors that can determine the speed at which the coprocessor device can execute program instructions include the bit width of operands and results.

In a data processing device that executes 128-bit instructions (e.g., those in an Streaming SIMD Extension (SSE) instruction set and/or similar instruction set) as a single instruction, up to three operand wires and one result wire for each of the 128-bit instructions (i.e., 512 wires) must be routed between the register file and each execution unit that requires its own operand and result busses. For instance, in a design that has 4 groups (or pipes) of execution units there would need to be up to 2048 wires routed to the register file.

To ease some of the wiring congestion, the execution units and the register file of the data processing device can be “split” into smaller 64-bit halves. One example of a split architecture is described, for example, in U.S. patent application Ser. No. 12/709,945, filed Feb. 22, 2010, entitled “INSTRUCTION PROCESSOR AND METHOD THEREFOR,” and assigned to the assignee of the present invention, which is incorporated herein by reference in its entirety. In one example that is disclosed in this application, each execution unit and each register file is split into two 64-bit halves. By splitting the register file and execution unit into two halves their independent 64-bit designs, two 64-bit halves are provided. An upper 64-bit half handles the upper 64-bit portion of each operand, and a lower 64-bit half handles the lower 64-bit portion of each operand. By splitting the register file and the execution units into two 64-bit portions, wiring congestion around the register file can be alleviated without incurring all of the design costs of multiple 128-bit data busses, 128-bit execution units and a 128-bit register file. It also allows the designs to be smaller which improves timing, power and other physical design considerations.

In the split design, the upper and lower 64-bit halves operate essentially as independent 64-bit designs. Although some 128-bit instructions do not require interaction between the upper and lower 64-bits of their operands or results (e.g., two 64-bit add instructions can be processed separately and then combined into a single 128 bit instruction; no data has to cross between the upper and lower 64-bits), other 128-bit instructions require that operand and/or result data be exchanged between the upper and lower 64-bit halves. To address this issue and support data exchange needed for some 128-bit instructions, a crossbar switch module can be provided to exchange data between the upper and lower 64-bit halves. The crossbar switch module can receive the upper 64-bit portion of each operand and the lower 64-bit portion of each operand, and generate a 128-bit result. The crossbar switch module is coupled to both the upper and lower 64-bit halves and can receive operands and results of both halves allowing it to receive and consume and produce 128-bit data and therefore handle 128-bit instructions that require data exchange between upper and lower 64-bit halves.

### BRIEF SUMMARY OF EMBODIMENTS

Although the crossbar switch module described above provides some of the basic functionality needed to support a split design, it does not allow for processing of instructions that require operands to be exchanged between the upper and lower 64-bit halves. For example, in some instructions, operands must be exchanged between the upper and lower 64-bit halves so that bytes and/or bits of the operands can be moved or rearranged to other positions during execution of a particular instruction. As such, it would be desirable to provide methods and apparatus that allow for various types of operand data movement/manipulation that may be required to implement instruction processing that may be required per various instructions, such as permute instructions. It would be desirable to provide this functionality.

In accordance with the disclosed embodiments, a microprocessor is provided that has a datapath that is split into upper and lower portions. The microprocessor includes a crossbar switch module having a single data movement module that can access and process all instructions that require simultaneous access to the entire register contents of the upper and lower portions. The data movement module is configured to execute any one of a number of different instructions to perform data manipulation with respect to one or more split-operands (e.g., between 1 and 3). The instructions that can be processed at the data movement module include, among others, permute, pack, shuffle, rotate instructions, etc. The instructions executed with respect to the one or more split-operands can include, for example, one or more of: a vectored conditional move instruction, a pack instruction, an unpack instruction, an extract instruction, a rotate instruction, a shift instruction or any other instruction in which operand data is manipulated, shifted, moved, re-ordered, shuffled or scrambled.

In accordance with the disclosed embodiments, a microprocessor is provided that has a datapath that is split into upper and lower portions. The microprocessor includes a crossbar switch module having a single data movement module that can access and process all instructions that require simultaneous access to the entire register contents of the upper and lower portions. The data movement module is configured to execute any one of a number of different instructions to perform data manipulation with respect to one or more split-operands (e.g., between 1 and 3). The instructions that can be processed at the data movement module include, among others, permute, pack, shuffle, rotate instructions, etc. The instructions executed with respect to the one or more split-operands can include, for example, one or more of: a vectored conditional move instruction, a pack instruction, an unpack instruction, an extract instruction, a rotate instruction, a shift instruction or any other instruction in which operand data is manipulated, shifted, moved, re-ordered, shuffled or scrambled.

In accordance with one of the disclosed embodiments, the data movement module is configured to execute an instruction to perform data manipulation with respect to first and second operands. The data movement module includes a first pipeline stage, a second pipeline stage, and a third pipeline stage. The first pipeline stage is configured to receive an upper-half of an operational code and to generate a first set of control bytes that correspond to the instruction that is to be performed with respect to each byte of an upper-half of a first operand and an upper-half of the second operand. The first pipeline stage is also configured to receive a lower-half of the operational code and to generate a second set of control bytes that correspond to the instruction that is to be performed with respect to each byte of a lower-half of the first operand and a lower-half of the second operand. Based on the first set of control bytes and the second set of control bytes, the second pipeline stage configured to select selected bytes from one or more of the upper-half of the first operand, the upper-half of the second operand, the lower-half of the first operand and the lower-half of the second operand, and swap (e.g., exchange or move) one or more of the selected bytes with another one of the selected bytes to generate resultant bytes of a byte swap stage intermediate result that comprises the resultant bytes arranged in the order specified by the permute operation. In other words, the second pipeline stage configured to select (for each of the 16 byte positions) any one of the bytes from the upper-half of the first operand, the upper-half of the second operand, the lower-half of the first operand and the lower-half of the second operand. The third pipeline stage is configured to split the byte swap stage intermediate result into an upper-half of the byte swap stage intermediate result, and a lower-half of the byte swap stage intermediate result, to shift bits of the upper-half of the byte swap stage intermediate result per an instruction in the upper-half of the decoded opcode to generate a bit-shifted version of the upper-half of the byte swap stage intermediate result, to shift bits of the lower-half of the byte swap stage intermediate result per an instruction in the lower-half of the decoded opcode to generate a bit-shifted version of the lower-half of the byte swap stage intermediate result, to select, based on the upper-half of the decoded opcode, either the upper-half of the byte swap stage intermediate result or the bit-shifted version of the upper-half of the byte swap stage intermediate result as an upper-half result, and to select, based on the lower-half of the decoded opcode, either the lower-half of the byte swap stage intermediate result or the bit-shifted version of the lower-half of the byte swap stage intermediate result as a lower-half result.

In accordance with another one of the disclosed embodiments, a method is provided for executing an instruction to perform data manipulation with respect to one or more split-operands. In separate paths, split operands are received. For example, upper-halves of the one or more split-operands comprising an upper-half of a first operand and an upper-half of a second operand, and lower-halves of the one or more split-operands comprising a lower-half of the first operand and a lower-half of the second operand are received. An upper-half of an operational code and a lower-half of the operational code can then be decoded to generate an upper-half decoded operational code, and a lower-half of the operational code to generate a lower-half decoded operational code.

A first set of control bytes and a second set of control bytes can then be generated that correspond to the instruction. For example, in one embodiment, a first set of control bytes can be generated that correspond to the instruction that is to be performed with respect to each byte of the upper-half of the first operand and the upper-half of the second operand. In one particular instance of this embodiment, each control byte of the first set of control bytes determines which instruction will be performed with respect to each corresponding byte of the upper-half of the first operand and the upper-half of the second operand. In one embodiment, a second set of control bytes can be generated that correspond to the instruction that is to be performed with respect to each byte of the lower-half of the first operand and the lower-half of the second operand. In one particular instance of this embodiment, each control byte of the second set of control bytes determines which instruction will be performed with respect to each corresponding byte of the lower-half of the first operand and the lower-half of the second operand.

During a two-cycle operation, operand read and data movement instruction lookup pipeline stage can simultaneously execute. In a two-cycle operation, the upper-half decoded operational code can be translated into a first set of control byte selection outputs, and based on the upper-half decoded operational code, one of the first set of control byte selection outputs can be selected as the first set of control bytes that correspond to each byte of the upper-half of the first operand and the upper-half of the second operand. Similarly, the lower-half decoded operational code can be translated into a second set of control byte selection outputs, and based on the lower-half decoded operational code, one of the second set of control byte selection outputs can be selected as the second set of control bytes that correspond to each byte of the lower-half of the first operand and the lower-half of the second operand.

By contrast, during a three-cycle operation, the operand read and data movement instruction lookup pipeline stage can separately execute, which adds an additional processing cycle. In the three-cycle variation, the upper-halves of the one or more split-operands further comprise an upper-half of a third operand, and the lower-halves of the one or more split-operands further comprise a lower-half of the third operand. In this scenario, first inputs are translated into a first set of control byte selection outputs, and second inputs are translated into a second set of control byte selection outputs. The first inputs comprise the upper-half decoded operational code, the upper-half of the first operand, the upper-half of the second operand, and the upper-half of the third operand, and the second inputs comprise the lower-half decoded operational code, the lower-half of the first operand, the lower-half of the second operand, and the lower-half of the third operand. Based on the upper-half decoded operational code, one of the first set of control byte selection outputs can be selected as the first set of control bytes that correspond to each byte of the upper-half of the first operand and the upper-half of the second operand. Based on the lower-half decoded operational code, one of the second set of control byte selection outputs can be selected as the second set of control bytes that correspond to each byte of the lower-half of the first operand and the lower-half of the second operand.

Based on the first set of control bytes and the second set of control bytes, one or more bytes selected from the upper-half of the first operand, the upper-half of the second operand, the lower-half of the first operand and the lower-half of the second operand can then be swapped. For example, in one embodiment, based on some of the bits of each of the first set of control bytes and the second set of control bytes, any number of selected bytes from one or more of the upper-half of the first operand, the upper-half of the second operand, the lower-half of the first operand and the lower-half of the second operand can be selected, and based on the first set of control bytes and the second set of control bytes, one or more of the selected bytes can be swapped with another one of the selected bytes to generate resultant bytes of a byte swap stage intermediate result. The byte swap stage intermediate result comprises the resultant bytes arranged in the order specified by the permute operation according to the first set of control bytes and the second set of control bytes.

In one implementation, for each particular one of the control bytes, based on some of the bits of that particular control byte, a selected byte from one of the upper-half of the first operand, the upper-half of the second operand, the lower-half of the first operand and the lower-half of the second operand can be selected. In one implementation, to swap the selected bytes, bits of the selected byte can be manipulated to generate manipulated versions of the selected byte. For example, at the second pipeline stage, individual bits can be manipulated such that the most significant bit (MSB) of each byte can be copied to other bits within the byte, or the bits within a byte can be reversed, etc. Otherwise, only complete bytes are moved from one byte to another. Based on other bits of the particular control byte, either the selected byte or one of the manipulated versions of the selected byte can be selected as one of the resultant bytes of the byte swap stage intermediate result.

In another implementation, the byte swap stage intermediate result can be staged through a flip-flop (or equivalent state element) and split into an upper-half of the byte swap stage intermediate result, and a lower-half of the byte swap stage intermediate result. Bits of the upper-half of the byte swap stage intermediate result can then be shifted or rotated, etc. per an instruction in the upper-half of the decoded opcode to generate a bit-shifted version of the upper-half of the byte swap stage intermediate result. Likewise, bits of the lower-half of the byte swap stage intermediate result can be shifted per an instruction in the lower-half of the decoded opcode to generate a bit-shifted version of the lower-half of the byte swap stage intermediate result.

Based on the upper-half of the decoded opcode, either the upper-half of the byte swap stage intermediate result or the bit-shifted version of the upper-half of the byte swap stage intermediate result can then be selected as an upper-half result, and, based on the lower-half of the decoded opcode, either the lower-half of the byte swap stage intermediate result or the bit-shifted version of the lower-half of the byte swap stage intermediate result can then be selected as a lower-half result. And, then, for example, in one exemplary implementation, bits in any particular byte of the upper-half of the byte swap stage intermediate result can be shifted or rotated (by up to a maximum of 7 bit positions) on byte, word, double word or quad word boundaries based on information specified in the upper-half of the decoded opcode to generate the bit-shifted version of the upper-half of the byte swap stage intermediate result, and any particular byte of the lower-half of the byte swap stage intermediate result can be shifted by (up to a maximum of 7 bit positions) on byte, word, double word or quad word boundaries based on information specified in the lower-half of the decoded opcode to generate the bit-shifted version of the lower-half of the byte swap stage intermediate result.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram illustrating a data processing device in accordance with a specific embodiment of the present disclosure.

FIG. 2 is a block diagram illustrating a portion of a coprocessor of FIG. 1 in accordance with a specific embodiment of the present disclosure.

FIG. 3A is a block diagram that illustrates an exemplary implementation of a data movement module that can be implemented in a crossbar switch module in accordance with some of the disclosed embodiments.

FIG. 3B is a block diagram that illustrates elements and data paths of the data movement instruction lookup pipeline stage of FIG. 3A that are involved when the particular operation being performed has three-cycle latency in accordance with one implementation of some of the disclosed embodiments.

FIG. 3C is a block diagram that illustrates elements and data paths of the operand read and data movement instruction lookup pipeline stage of FIG. 3A that are involved when the particular operation being performed has two-cycle latency in accordance with one implementation of some of the disclosed embodiments.

FIG. 4A is a diagram that illustrates a three-cycle latency operation including the processing performed at various pipeline stages of the data movement module in accordance with one implementation of some of the disclosed embodiments.

FIG. 4B is a diagram that illustrates a two-cycle latency operation including the processing performed at various pipeline stages of the data movement module in accordance with one implementation of some of the disclosed embodiments.

FIG. 5 is a block diagram that illustrates an exemplary implementation of a byte swapper module of the data movement module illustrated in FIG. 3A in accordance with one implementation of some of the disclosed embodiments.

FIG. 6 is a block diagram that illustrates an exemplary implementation of one byte swapper sub-module that can be implemented in the byte swapper module of FIG. 5 in accordance with one implementation of some of the disclosed embodiments.

FIG. 7 is a diagram that illustrates processing of a 16-byte first operand during a shift right arithmetic double-word by 12 bits operation performed by the byte swapper module in accordance with an exemplary implementation of one possible instruction of the disclosed embodiments.

FIG. 8 is a diagram that illustrates processing of a 16-byte first operand and a 16-byte second operand during an unpack and interleave low double words operation performed by the byte swapper module in accordance with an exemplary implementation of one possible instruction of the disclosed embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to functional aspects of the devices and systems (and the individual operating components of the devices and systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment.

### DEFINITIONS

As used herein, the term “instruction set architecture” refers to a part of the computer architecture related to programming, including the native data types, instructions, registers, addressing modes, memory architecture, interrupt and exception handling, and external I/O. An instruction set architecture includes a specification of a set of machine language “instructions.”

As used herein, the term “instruction” refers to an element of an executable program provided to a processor by a computer program that describes an operation that is to be performed or executed by the processor. An instruction may define a single operation of an instruction set. Types of operations include, for example, arithmetic operations, data copying operations, logical operations, and program control operation, as well as special operations, such as permute operations. A complete machine language instruction includes an operation code or “opcode” and, optionally, one or more operands.

As used herein, the term “opcode” refers to a portion of a machine language instruction that specifies or indicates which operation (or action) is to be performed by a processor on one or more operands. For example, an opcode may specify an arithmetic operation to be performed, such as “add contents of memory to register,” and may also specify the precision of the result that is desired. The specification and format for opcodes are defined in the instruction set architecture for a processor (which may be a general CPU or a more specialized processing unit). An opcode is a numerical representation of an instruction, and can be represented by text, abbreviations and/or mnemonics.

As used herein, the term “operand” refers to the part of an instruction which specifies what data is to be manipulated or operated on, while at the same time also representing the data itself. In other words, an operand is the part of the instruction that references the data on which an operation (specified by the opcode) is to be performed. Operands may specify literal data (e.g., constants) or storage areas (e.g., addresses of registers or other memory locations in main memory) that may contain data to be used in carrying out the instruction.

As used herein, the term “instruction” refers to a data movement instruction that allows any arbitrary byte and/or bit from one or more operands to be moved, shifted, re-ordered, shuffled or scrambled to any arbitrary byte and/or bit position in a result. In one embodiment, an instruction refers to a 128-bit data movement instruction that can arbitrarily select 16 result bytes from any of 32 operand bytes, then independently invert, reverse, or sign extend the selected bytes or force them to zero or 1, then shift them by up to 7 bits on byte, word, double word or quad word boundaries to produce the final 128-bit result. Examples of such instructions include vectored conditional move instructions, pack instructions and unpack instructions, extract instructions, rotate instructions, shift instructions and any other instructions in which operand data (bytes and/or bits) is manipulated. Instructions can be used manipulate elements (bytes, bits, etc.) of one or more operands, making them particularly useful for data processing and compression. Instructions may be generally be categorized into one of the following categories:

1. Move (where data moves within registers) and conditional move

2. Pack and unpack

3. Extract/Insert word

4. Permute and shuffle

5. Rotate and shift

As used herein, the term “swapping” includes one or more of shifting, moving, re-ordering, shuffling or scrambling one or more selected bytes of one or more split-operands with respect to another one of the selected bytes to generate resultant bytes of a byte swap stage intermediate result.

### Overview

In accordance with the disclosed embodiments, a microprocessor is provided that has a datapath that is split into upper and lower portions. The microprocessor includes a centralized crossbar switch module having a single data movement module. The data movement module is capable of processing instructions that require operands to be exchanged between upper and lower 64-bit halves of the split architecture. The data movement module can access and process all instructions that require simultaneous access to the entire register contents of the upper and lower portions. The data movement module is configured to execute any one of a number of different instructions to perform data manipulation with respect to one or more “split-operands” (also referred to simply as “operands” herein). The data movement module can exchange data (bytes and/or bits) of operands for the upper and lower 64-bit halves so that bytes and/or bits of operands can be moved or rearranged to other positions during execution of a particular instruction. The data movement module can allow for various types of operand data movement/manipulation that may be required to implement instruction processing that may be required per various instructions, such as permute, pack, shuffle, rotate instructions, etc. Examples of the instructions that can be processed at the data movement module and executed with respect to the one or more split-operands can include, for example, one or more of: a vectored conditional move instruction, a pack instruction, an unpack instruction, an extract instruction, a rotate instruction, a shift instruction or any other instruction in which operand data is manipulated, shifted, moved, re-ordered, shuffled or scrambled.

### Exemplary Data Processor

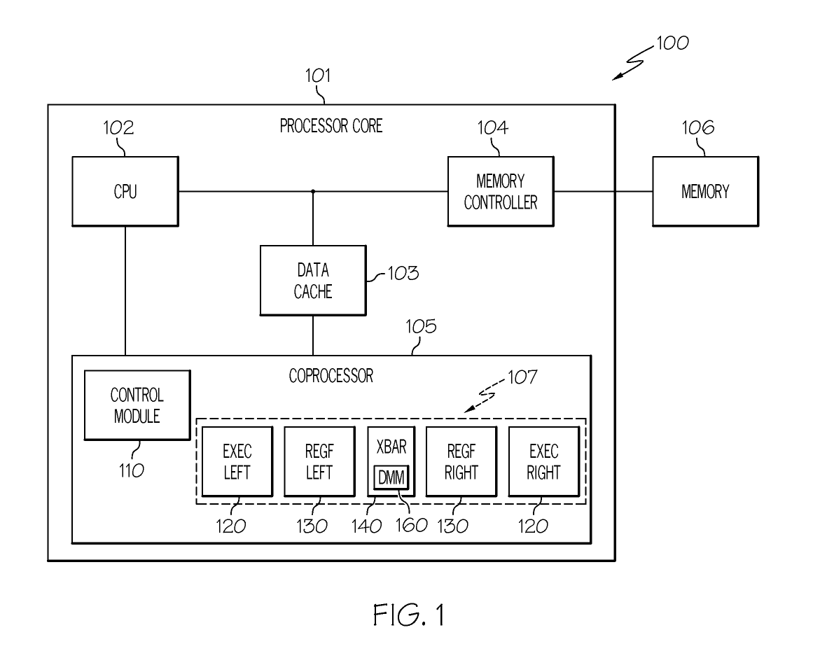

FIG. 1 is a block diagram illustrating a data processing device 100 in accordance with a specific embodiment of the present disclosure. Data processing device 100 includes a processor core 101 and a memory device 106.

Processor core 101 can be formed as an integrated circuit device that includes a central processing unit (CPU) 102, a data cache memory 103, a memory controller 104, and a coprocessor 105. Coprocessor 105 is a data processor that can implement various arithmetic operations, and includes a control module 110, an execution unit 120 having a left portion 121 and a right portion 122, a register file 130 having a left portion, register file portion 131, and a right portion, register file portion 132, and a crossbar switch module 140 that includes a data movement module (DMM) 160. It will be appreciated that while coprocessor 105 is illustrated as being separate from CPU 102, the features of coprocessor 105 can also be implemented as part of one or more data processors within CPU 102. Additionally, coprocessor 105 can be implemented as a device separate from processor core 101 such as, for example, as a discrete device.

Coprocessor 105 is configured to execute one or more program instructions, such as general purpose arithmetic instructions associated with a specific program. For example, execution unit 120 can execute an arithmetic program instruction wherein a portion of the program instruction is executed at execution unit portion 121 of execution unit 120 and another portion of the arithmetic instruction is executed at execution unit portion 122 of execution unit 120. Furthermore, coprocessor 105 is configured to store data information to be manipulated by the arithmetic instruction, e.g., an operand of the arithmetic instruction, as two portions, one portion stored at register file portion 131 and the other portion stored at register file portion 132.

During operation of data processing device 100, CPU 102 can access program instructions stored at memory device 106 via memory controller 104. A program instruction can be associated with different classes of instructions. A specific class of program instructions can be limited to execution at a specific data processor, such as coprocessor 105, or can be executed at more than one data processor. For example, some SIMD instructions may be limited to being executed at coprocessor 105, while some SISD instruction cannot be executed at coprocessor 105. In addition, some SIMD and SISD instruction may be executed at an execution unit included within CPU 102 (not shown), or within coprocessor 105. It will be appreciated that a program instruction can exhibit characteristics of different classes of instructions. For example, an program instruction can exhibit characteristics of both a SIMD instruction and a SISD instruction, such as an instruction that multiplies a plurality of operational operands independent of each other storing the independent results in a common register of register file 130, similar to a SIMD instruction, and then adds the plurality of independent results to form a single accumulated result that is stored at a register of register file 130, similar to a SISD instruction.

SIMD instructions are particularly well suited for implementing graphics and signal processing related algorithms. As discussed previously, a SIMD instruction can designate that a specified arithmetic operation be performed a plurality of times on a corresponding plurality of operational operands that make up a single operand of the SIMD instruction. For example, an operand of the SIMD instruction stored at a register of register file 130 includes a first portion of the operand stored at a first portion of the register, e.g., a portion of the register at register file portion 131, and a second portion of the operand stored at a second portion of the register, e.g., a portion of the register at register file portion 132. Therefore, a SIMD instruction that performs eight add operations on 16-bit operational operands can be executed by coprocessor 105 accessing two 128-bit operands stored at two different registers of register file 130. Whereby, each of the two 128-bit operands would include eight addends (e.g., eight operational operands, four of which are stored at register file portion 131 and four of which are stored at register file portion 132) that are operated upon independently to provide eight individual results.

Another type of arithmetic instruction, as discussed previously, includes an SISD instruction. An SISD instruction designates that a specified arithmetic operation be performed a single time on a single operational operand, e.g., there is one operational operand per operand. With respect to coprocessor 105, a portion of an operational operand is stored at a register portion at register file portion 131 and another portion of the operational operand is stored at the corresponding register portion at register file portion 132. For example, a SISD instruction that adds two operational operands may be executed by coprocessor 105 to perform a single 128-bit addition operation on two 128-bit operational operands that correspond to two 128-bit operands stored at different registers of register file 130 in order to provide a single 128-bit result, where each register stores data information representing a single operational operand. In an embodiment, each register at register file 130 can include 128 bits of information, wherein 64-bits of the data information is stored at a register portion at register file portion 131 and another 64-bits of the data information is stored at a corresponding register portion at register file portion 132.

Coprocessor 105 includes a control module 110 to manage operation of coprocessor 105, including the receipt of arithmetic program instructions at coprocessor 105, access of operands associated with program instructions, and scheduling and control of the interaction between execution unit 120, register file 130, and crossbar switch module 140. In an embodiment, control module 110 includes a micro-sequencer device (not shown) operable to execute micro-code instructions stored at a micro-code memory device. The micro-sequencer device, in addition to other logic modules included at control module 110, can configure modules at coprocessor 105 to implement a sequential procedure to perform the operation specified by an arithmetic program instruction.

When executing a SIMD instruction, execution unit portion 121 and execution unit portion 122 operate substantially autonomously whereby each portion can independently perform one or more arithmetic operations independent of any data information from the other portion. For example, execution unit portion 121 and execution unit portion 122 can each include an access control module that provides access requests to its respective portion of the register file to access information, and each execution unit portion can perform individual arithmetic operations associated with a respective portion of a SIMD instruction. When executing a SISD instruction, execution unit portion 121 and execution unit portion 122 can together perform a single operation associated with a SISD program instruction, wherein crossbar switch module 140 is configured to transfer data information between execution unit portion 121 and execution unit portion 122 (using register file 130) to facilitate the execution of the SISD program instruction. Accordingly, execution unit portion 121 and execution unit portion 122 can together execute a single program instruction, wherein each operand associated with the program instruction includes more bits of data information than can be processed by either execution unit portion 121 or execution unit portion 122 individually. It will be appreciated that coordination between the various portions of an execution unit to complete a SISD instruction can be controlled by the control module 110, which can coordinate a transfer of information based upon communications from one or more of execution unit portion 121 and execution unit portion 122, and which can coordinate a transfer of information based upon defined timing requirements of execution unit portion 121 and execution unit portion 122.

Data information can be stored at a register of register file 130 by control module 110. For example, control module 110 can store an operand received from data cache memory 103 to a register at register file 130, whereby a first portion of the operand is stored at a location of register file portion 131 corresponding to the register, and a second portion of the operand stored at a location of register file portion 132 corresponding to the register. Each portion of execution unit 120 is associated with a corresponding register file portion in that it can access only one of the two register file portions directly. For example, execution unit portion 121 can directly access (store and retrieve) data information at register file portion 131, and execution unit portion 122 can directly access data information at register file portion 132. Data information can be stored at each portion of register file 130 by providing a store access request that includes an address identifying a register portion location, providing data information to be stored at the register portion, and asserting appropriate control signals, such as a write enable signal. Data information can be retrieved from each portion of register file 130 by providing a load access request that includes an address identifying the location of the register portion to be read, and asserting appropriate control signals, such as a read enable signal.

Each register file portion of register file 130 includes a plurality of access ports, each access port to receive a corresponding set of control signals, and each access port operable to provide access to a portion of each register of register file 130. For example, register file portion 131 can include the 64 most-significant bits of each one of a plurality of data registers at register file 130, while register file portion 132 can include the 64 least-significant bits of each one of the plurality of data registers. In addition, each of register file portion 131 and 132 can include a plurality of access ports. For example, they each can include ten read access ports to provide data information in response to a read access request and six write ports to receive and store data information in response to a write access request. In an embodiment, coprocessor 105 includes multiple execution units (not illustrated), in addition to execution unit 120, with each execution unit having two physically separate portions that reside close to a corresponding portion of the register file to access data information stored at register file portion 131 and register file portion 132 independently.

Cross bar switch 140 is configured to transfer data information between register portions at register file portions 131 and 132. For example, crossbar switch module 140 can retrieve data information stored at a portion of a register, e.g., register portion 132 using one access port of a set of access ports of register portion 132 to read the stored information, and store data information at another portion of the register, e.g., register portion 131 using one access port of a set of access ports at register portion 131 to store the information being transferred. Thus, crossbar switch module 140 can enable the sharing of data information between the physically separate portions of execution unit 120. For example, when execution unit portion 121 and execution unit portion 122 are together performing a SISD arithmetic operation, intermediate calculation results can be exchanged between each portion of execution unit 120 via crossbar switch module 140 by way of respective portions 131 and 132 of register file 130.

In one embodiment, crossbar switch module 140 is configured to perform a desired transfer of data information in response to one or more opcodes executed by control module 110. In another embodiment, crossbar switch module 140 can perform operations that manipulate data that is being transferred between two register portions at register file 130, such as operations that format data or that shift blocks of data amongst the data ports, where a block of data is associated with a specific data unit, such as a bit, a nibble, a byte, and the like.

In one embodiment, register file portion 131, crossbar switch module 140, and register file portion 132 are positioned between execution unit portion 121 and execution unit portion 122. For example, the locations of register file portion 131, register file portion 132, execution unit portion 121, execution unit portion 122, and crossbar switch module 140 as illustrated in FIG. 1 can represent their layout locations with respect to each other. Accordingly, execution unit portion 121 is not contiguous with execution unit portion 122. By organizing the placement of these blocks in this manner, the physical length of signal interconnects that connect an execution unit portion with a corresponding register file portion can be reduced relative to other placement configurations, and thereby reducing the propagation delay of signals carried by the signal interconnects. Accordingly, the operating frequency of coprocessor 105 can be increased relative to other placement configurations.

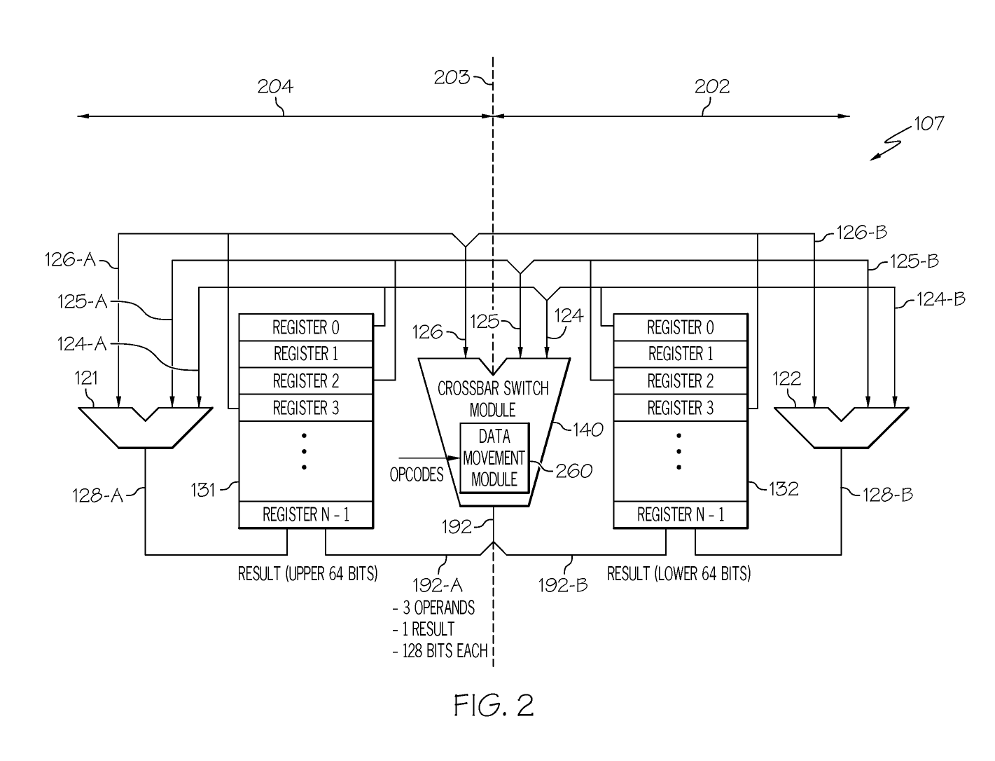

FIG. 2 is a block diagram illustrating a portion 107 of a coprocessor 105 of FIG. 1 in accordance with a specific embodiment of the present disclosure. In FIG. 2, wiring connections between the crossbar switch module 140, the register file portions 131, 132 and execution units 121, 122 are illustrated in greater detail. The portion 107 of the coprocessor 105 can be subdivided into an upper-half 204 and a lower-half 202 as indicated by dashed boundary line 203. This way, the execution unit 120 can be physically sub-divided into an upper-half execution unit 121 and lower-half execution unit 122, and the register file 130 can be physically sub-divided into an upper-half register file portion 131 and lower-half register file portion 132. Each register of register file portions 131, 132 can store operands.

The upper-half execution unit 121 receives three 64-bit split-operands 124-A, 125-A, 126-A and uses them to generate a 64-bit result 128-A that can be written to the upper-half register file portion 131, and lower-half execution unit 122 receives three 64-bit split-operands 124-B, 125-B, 126-B and uses them to generate a 64-bit result 128-B that can be written to the lower-half register file portion 132.

The crossbar switch module 140 can communicate with both the register file portions 131, 132 and execution units 121, 122. The crossbar switch module 140 receives or “consumes” up to three 128-bit operands 124, 125, 126, and generates or produces one 128-bit result 192. The crossbar switch module 140 provides basic data transfer functionality that allows for data movement between the upper-half 204 and the lower-half 202.

More specifically, the upper-half register file portion 131 can provide an upper-half of the first operand 124-A from a first register, an upper-half of the second operand 125-A from a second register, and an upper-half of the third operand 126-A from a third register. Similarly, the lower-half register file portion 132 can provide a lower-half of the first operand 124-B from a first register, a lower-half of the second operand 125-B from a second register, and a lower-half of the third operand 126-B from a third register. Although not illustrated, the crossbar switch module 140 can also receive operands from other execution units via bypass pipelines. The operands 124-A, 124-B, 125-A, 125-B, 126-A, 126-B are each 64 bits in width. The upper-half of the first operand 124-A and the lower-half of the first operand 124-B taken together constitute a first 128-bit operand 124.

The 128-bit result 192 can be split into two 64-bit results 192-A, 192-B. The two 64-bit results 192-A, 192-B can then be written back to the upper-half register file portion 131 and the lower-half register file portion 132, respectively.

Although the crossbar switch module 140 allows simple data transfer operations for some classes of instructions it would be beneficial if the crossbar switch module 140 could perform processing needed to execute instructions such as those describe above.

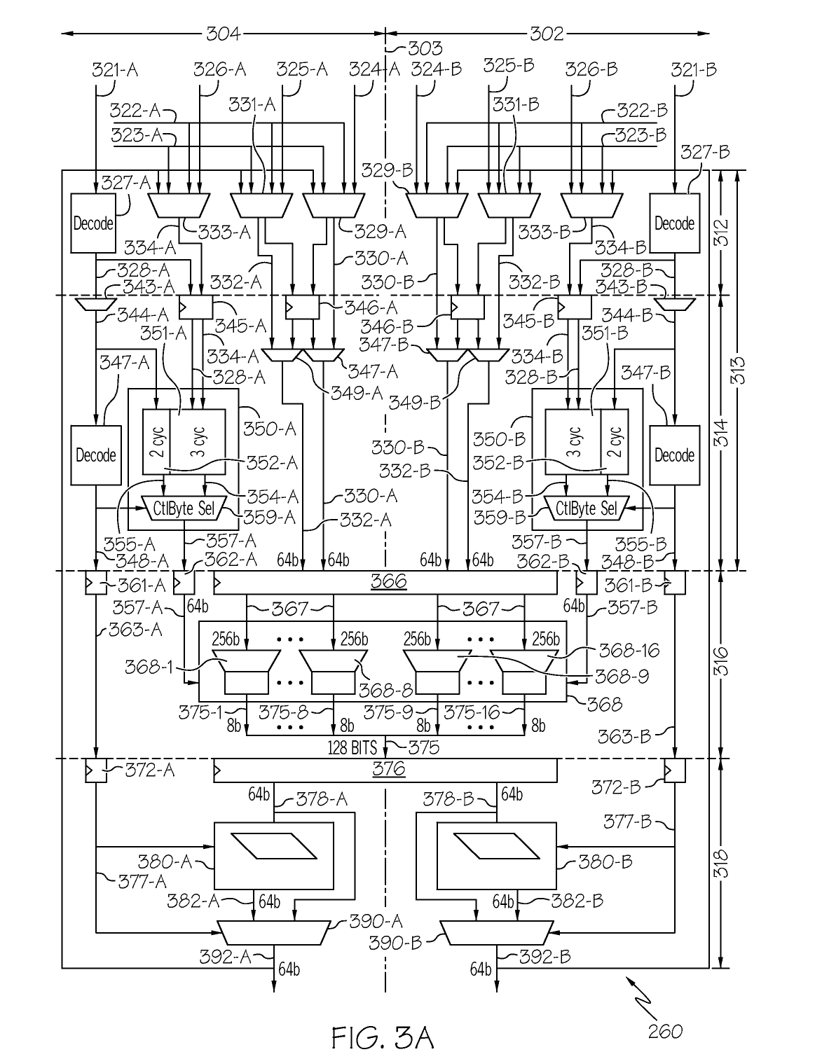

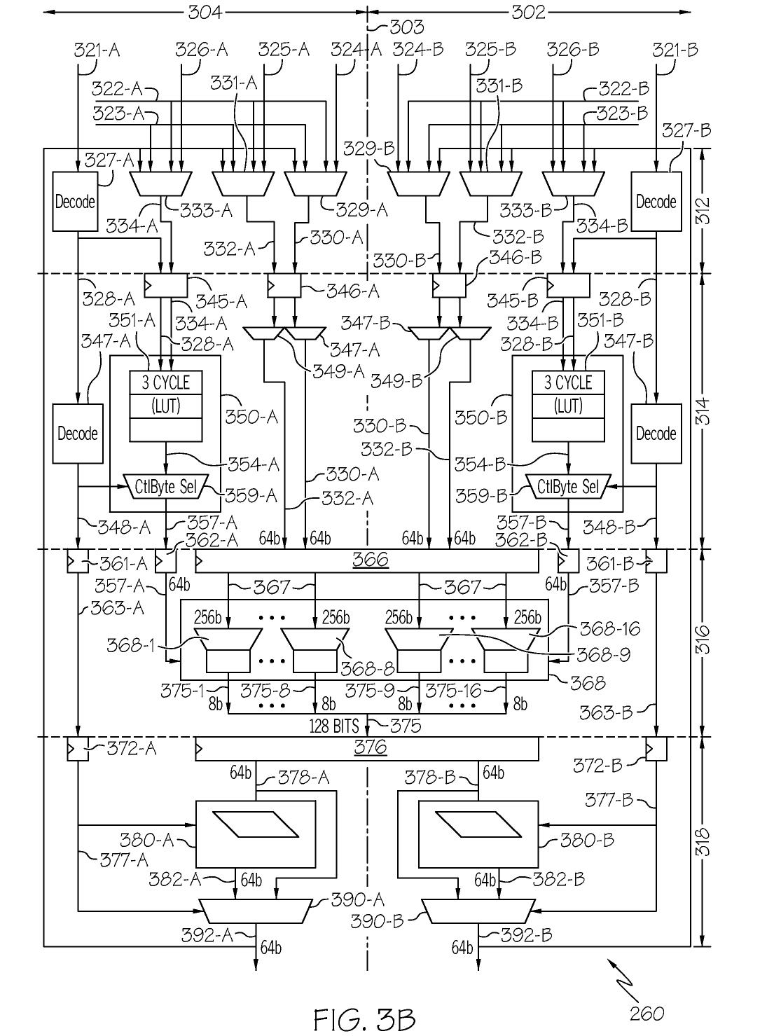

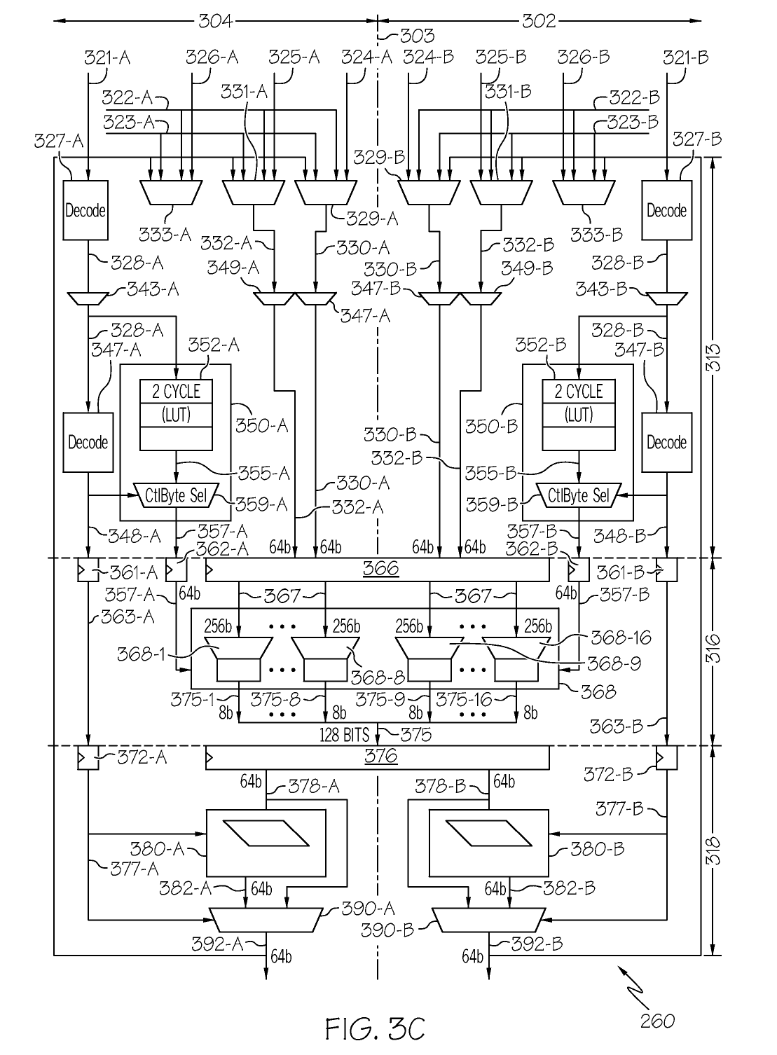

In accordance with the disclosed embodiments, a crossbar switch module 140 is provided that includes a data movement module 260 that provides functionality required to perform data movement instruction processing. Because the data movement module 260 is incorporated within the crossbar switch module 140 it's centrally located with respect to both the register files 131, 132 and execution units 121, 122. The data movement module 260 performs various data manipulation instructions with respect to the operands. Examples of such data manipulation instructions include vectored conditional move instructions, pack instructions and unpack instructions, extract instructions, rotate instructions, shift and any other instructions in which operand data (bytes and/or bits) is manipulated, shifted, moved, re-ordered, shuffled or scrambled. Various features of the data movement module 260 of a crossbar switch module 140 will now be described with reference to FIG. 3A-3C.

FIG. 3A is a block diagram that illustrates an exemplary implementation of a data movement module 260 that can be combined with a crossbar switch module 140 in accordance with some of the disclosed embodiments. As illustrated in FIG. 3A, portions of the data movement module 260 are divided into a upper-half 304 and a lower-half 302. The upper-half 304 processes the high or upper 64 bits of operands or results, and the lower-half 302 processes the low or lower 64 bits of operands or results, and can therefore also be referred to as a high or upper-half 64-bit portion, and a low or lower-half 64-bit portion, respectively. To provide this permute functionality, the data movement module 260 and the crossbar switch module 140 operate in either four or five pipeline stages including an opcode and operand delivery pipeline stage (not illustrated), an operand read pipeline stage 312, a data movement instruction lookup pipeline stage 314, a byte swap pipeline stage 316 and a bit swizzle pipeline stage 318. When the data movement module 260 and the crossbar switch module 140 operate in four pipeline stages, the operand read pipeline stage 312 and the data movement instruction lookup pipeline stage 314 of FIG. 3A are effectively combined into a single operand read and data movement instruction lookup pipeline stage 313 as will be described below with reference to FIG. 3C.

### Operand Read Pipeline Stage

A scheduler delivers the opcode 321, a portion of the opcode and operand delivery pipeline stage that is implemented in the data movement module 260, where they are latched and then communicated to the operand read pipeline stage 312.

The upper-half 304 and lower-half 302 each receive three split-operands 324, 325, 326. The split-operands 324, 325, 326 can come from either a register file or can be bypassed from other units or bypass pipelines. The terms “operand,” “operands” and “bypassed result” are used interchangeably herein. With respect to the upper-half 304, an opcode 321-A, an upper-half of a first bypassed result 322-A generated by a first bypass pipeline (not illustrated), an upper-half of the second bypassed result 323-A generated by the second bypass pipeline (not illustrated), an upper-half of the first operands 324-A from the upper-half register file, an upper-half of the second operands 325-A from the upper-half register file, and an upper-half of the third operands 326-A from the upper-half register file, are provided to the upper-half 304 of the operand read pipeline stage 312. With respect to the lower-half 302, an opcode 321-B, a lower-half of the first bypassed result 322-B generated by the first bypass pipeline (not illustrated), a lower-half of the second bypassed result 323-B generated by the second bypass pipeline (not illustrated), a lower-half of the first operands 324-B from the lower-half register file, a lower-half of the second operands 325-B from the lower-half register file, and a lower-half of the third operands 326-B from the lower-half register file are provided to the lower-half 302 of the operand read pipeline stage 312.

The upper-half 304 of the operand read pipeline stage 312 includes a first operand selection multiplexer 329-A, a second operand selection multiplexer 331-A, a third operand selection multiplexer 333-A and a decoder module 327-A. The decoder module 327-A receives and decodes opcode 321-A, and provides the decoded opcode 328-A to the data movement instruction lookup pipeline stage 314. For ease of illustration, decoder modules 327-A are shown in the upper-half 304 of the operand read pipeline stage 312; however, in some implementations each of the other pipeline stages 316, 318 can include decoder modules (not illustrated) that operate on and further decode the decoded opcode 328-A. To illustrate this concept, the decoded opcode is labeled 328-A, 348-A, 363-A, 363-A as it traverses and is decoded at the various pipeline stages 312, 314, 316, 318.

The first operand selection multiplexer 329-A receives an upper-half of a first bypassed result 322-A generated by a first bypass pipeline (not illustrated), an upper-half of the second bypassed result 323-A generated by a second bypass pipeline (not illustrated), an upper-half of a first operands 324-A from an upper-half register file, and an upper-half result 392-A generated by the upper-half 304 of the data movement module 260, and selects one of these inputs and outputs the selected input as an upper-half of a first operand 330-A to the data movement instruction lookup pipeline stage 314. In a three-cycle latency implementation, the upper-half of the first operand 330-A is provided to the flip-flop 346-A and then to the multiplexer 347-A, and in a two-cycle latency implementation, the upper-half of the first operand 330-A can be provided directly to the multiplexer 347-A.

Similarly, the second operand selection multiplexer 331-A receives the upper-half of a first bypassed result 322-A generated by a first bypass pipeline (not illustrated), the upper-half of the second bypassed result 323-A generated by the second bypass pipeline (not illustrated), the upper-half of the second operands 325-A from the upper-half register file, and the upper-half result 392-A generated by the upper-half of the data movement module 260 of a crossbar switch module 240, and selects one of these inputs and outputs the selected input as an upper-half of the second operand 332-A to the data movement instruction lookup pipeline stage 314. In a three-cycle latency implementation, the upper-half of the second operand 332-A is provided to the flip-flop 346-A and then to the multiplexer 347-A, and in a two-cycle latency implementation, the upper-half of the second operand 332-A can be provided directly to the multiplexer 347-A.

Likewise, the third operand selection multiplexer 333-A receives the upper-half of a first bypassed result 322-A generated by a first bypass pipeline (not illustrated), the upper-half of the second bypassed result 323-A generated by the second bypass pipeline (not illustrated), the upper-half of a third operands 326-A from the upper-half register file and the upper-half result 392-A generated by the upper-half of the data movement module 260, and selects one of these inputs and outputs the selected input as an upper-half of the third operand 334-A to the data movement instruction lookup pipeline stage 314.

Similar to the architecture of the upper-half 304, the lower-half 302 of the operand read pipeline stage 312 includes a first operand selection multiplexer 329-B, a second operand selection multiplexer 331-B, a third operand selection multiplexer 333-B and a decoder module 327-B. The decoder module 327-B receives and decodes opcode 321-B, and provides the decoded opcode decoded opcode 328-B to the data movement instruction lookup pipeline stage 314. For ease of illustration, decoder modules 327-B, 347-B are shown in the lower-half 302 of the pipeline stages 312, 314; however, in some implementations each of the other pipeline stages 316, 318 can include decoder modules (not illustrated) that operate on and further decode the decoded opcode 328-B. To illustrate this concept, the decoded opcode is labeled 328-B, 348-B, 363-B, 377-B as it traverses and is decoded at the various pipeline stages 312, 314, 316, 318.

The first operand selection multiplexer 329-B receives the lower-half of the first bypassed result 322-B generated by the first bypass pipeline (not illustrated), the lower-half of the second bypassed result 323-B generated by the second bypass pipeline (not illustrated), the lower-half of the first operands 324-B from the lower-half register file, and a lower-half result 392-B generated by the lower-half 302 of the data movement module 260 of a crossbar switch module 240, and selects one of these inputs and outputs the selected input as a lower-half of the first operand 330-B to the data movement instruction lookup pipeline stage 314. In a three-cycle latency implementation, the lower-half of the first operand 330-B is provided to the flip-flop 346-B and then to the multiplexer 347-B, and in a two-cycle latency implementation, the lower-half of the first operand 330-B can be provided directly to the multiplexer 347-B.

Similarly, the second operand selection multiplexer 331-B receives the lower-half of the first bypassed result 322-B generated by the first bypass pipeline (not illustrated), the lower-half of the second bypassed result 323-B generated by the second bypass pipeline (not illustrated), the lower-half of the second operands 325-B from the lower-half register file, and the lower-half result 392-B generated by the lower-half 302 of the data movement module 260 of a crossbar switch module 240, and selects one of these inputs and outputs the selected input as a lower-half of the second operand 332-B to the data movement instruction lookup pipeline stage 314. In a three-cycle latency implementation, the lower-half of the second operand 332-B is provided to the flip-flop 346-B and then to the multiplexer 349-B, and in a two-cycle latency implementation, the lower-half of the second operand 332-B can be provided directly to the multiplexer 349-B.

Likewise, the third operand selection multiplexer 333-B receives the lower-half of the first bypassed result 322-B generated by the first bypass pipeline (not illustrated), the lower-half of the second bypassed result 323-B generated by the second bypass pipeline (not illustrated), the lower-half of the third operands 326-B from the lower-half register file, and the lower-half result 392-B generated by the lower-half 302 of the data movement module 260 of a crossbar switch module 240, and selects one of these inputs and outputs the selected input as a lower-half of the third operand 334-B to the data movement instruction lookup pipeline stage 314.

It is noted that throughout the various drawings in this application, a group of flip-flops may be illustrated using a single flip-flop symbol and for sake of brevity may be referred to as a flip-flop. In a strict sense, a flip-flop is a state element capable of holding a single bit of information. However, as used herein, the term “flip-flop” refers to a state element capable of holding one bit or a plurality of bits of information. As such, it will be appreciated by those skilled in the art that in this document that any flip-flop illustrated in the drawings (or referred to herein as a “flip-flop”) can be a state element that is capable of holding one or more bits of information. In some implementations, a flip-flop may be implemented using one or more flip-flop circuits that are each capable of holding one bit of information.

### Data Movement Instruction Lookup Pipeline Stage

The upper-half 304 of the data movement instruction lookup pipeline stage 314 includes a flip-flop 345-A, a flip-flop 346-A, multiplexers 343-A, 347-A, 349-A, and a permute control module 350-A. The permute control module 350-A includes a lookup table (LUT) 351-A. 352-A, and a control byte selection multiplexer 359-A. Likewise, the lower-half 302 of the data movement instruction lookup pipeline stage 314 includes a flip-flop 345-B, a flip-flop 346-B, multiplexers 343-B, 347-B, 349-B, and a permute control module 350-B. The permute control module 350-B includes a lookup table (LUT) 351-B, 352-B and a control byte selection multiplexer 359-B.

### Variable Latency Processing

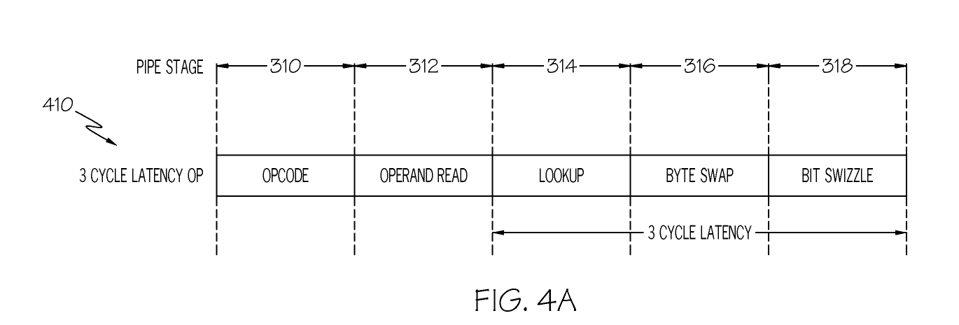

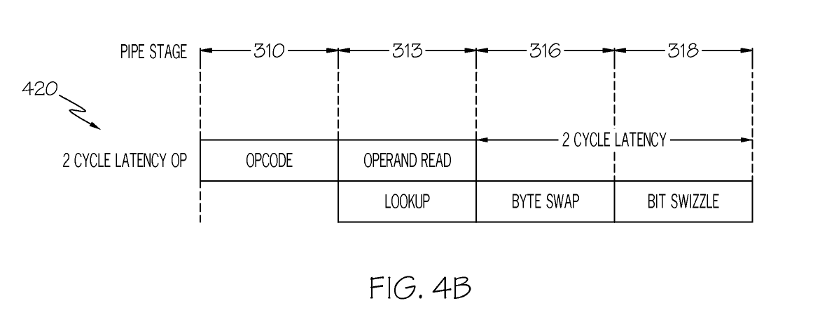

In accordance with the disclosed embodiments, instructions can be processed with either three-cycle latency (i.e., latency involved in processing operands is three cycles after the operand read pipeline stage 312) or two-cycle latency (i.e., latency in processing operands is two cycles after the combined Operand Read and Data movement instruction lookup pipeline stage 313). The processing of the operands that are received in the operand read pipeline stage 312 stage will vary depending on which instruction is being performed and the complexity of the instruction. This “variable latency” concept is illustrated in FIGS. 3B and 4A (three-cycle latency) and in FIGS. 3C and 4B (two-cycle latency).

### Operation of Data Movement Instruction Lookup Pipeline Stage 314 During a Three-Cycle Operation

FIG. 3B is a block diagram that illustrates elements and data paths of the data movement instruction lookup pipeline stage 314 of FIG. 3A that are involved when the particular operation being performed has three-cycle latency in accordance with some of the disclosed embodiments. FIG. 4A is a diagram that illustrates a three-cycle latency operation 410 including the processing performed at various pipeline stages 312, 314, 316, 318 of the data movement module 260 in accordance with some of the disclosed embodiments. As will be explained below, for more complex instructions that require an opcode decode, the lookup is done after the operands have been delivered to the operand read pipeline stage 312, all four pipeline stages 312, 314, 316, 318 are used, and all of the functional elements illustrated in the data movement instruction lookup pipeline stage 314 are involved in processing to determine the controls for subsequent stages 316, 318. Three processing cycles are required after the operand read pipeline stage 312, and therefore these permute operations are referred to as three-cycle latency operations. To explain further, three-cycle latency operations generally have three operands. The third operand is not data to be manipulated, but instead provides more detail about what operation is to be done to the other two operands. It is essentially an extension of the opcode and must be fully decoded with the lookup table to know how to process the operands. Since the operation is specified in the opcode and in the third operand, decoding it is more complex and takes more time. So the operands must be staged from 312 into 314 while an extra cycle is spent decoding the operation from the opcode and the third operand. By the start of the swap stage 316, the operation is fully decoded regardless of the op latency and data processing begins. These operations complete 3 cycles after the stage 312.

As illustrated in FIG. 3B, the decoded opcode 328-A is passed to decoder 347-A and the flip-flop 345-A. The decoder 347-A can perform further decoding of the decoded opcode 328-A to generate decoded opcode 348-A.

The flip-flop 345-A receives the upper-half of the third operand 334-A, and provides it to the lookup table (LUT) 351-A along with the decoded opcode 328-A. The upper-half of the third operand 334-A is required for some complex instructions.

The flip-flop 346-A also provides the upper-half of the first operand 330-A, and the upper-half of the second operand 332-A to the multiplexers 347-A, 349-A, respectively.

The multiplexer 347-A sends the upper-half of the first operand 330-A to flip-flop 366, and the multiplexer 349-A sends the upper-half of the second operand 332-A to the flip-flop 366. The upper-half of the first operand 330-A and the upper-half of the second operand 332-A are each 8 bytes (or 64 bits).

At the permute control module 350-A, the decoded opcode 348-A is translated or remapped into control bytes 357-A, which are generic instructions. A unique control byte 357-A is generated for each of the 8 bytes 330-A, 332-A in the upper-half 304 of the datapath. To do so, the permute control module 350-A includes the lookup table (LUT) 351-A and the control byte selection multiplexer 359-A.

The lookup table (LUT) 351-A receives the decoded opcode 328-A, and the upper-half of the third operand 334-A, and based on these inputs, generates and outputs a set of control byte selection outputs 354-A.

The control byte selection multiplexer 359-A receives the set of control byte selection outputs 354-A and the decoded opcode 348-A. Based on the decoded opcode 348-A, the control byte selection multiplexer 359-A selects one of the set of control byte selection outputs 354-A and generates eight unique control bytes 357-A (i.e., one control byte corresponding to each byte in the upper-half 304 of the datapath). The control bytes 357-A correspond to various instructions that are to be performed to allow for the data movement required by those instructions. The control bytes 357-A determine which instruction will be performed with respect to each byte of the upper-half of the first operand 330-A and the upper-half of the second operand 332-A.

As illustrated in FIG. 3B, the decoded opcode 328-B is passed to decoder 347-B and the flip-flop 345-B. The decoder 347-B can perform further decoding of the decoded opcode 328-B to generate decoded opcode 348-B.

The flip-flop 345-B receives the lower-half of the third operand 334-B, and provides it to the lookup table (LUT) 351-B along with the decoded opcode 328-B. The lower-half of the third operand 334-B is required for some complex instructions.

The flip-flop 346-B also provides the lower-half of the first operand 330-B, and the lower-half of the second operand 332-B to the multiplexers 347-B, 349-B, respectively.

The multiplexer 347-B sends the lower-half of the first operand 330-B to flip-flop 366, and the multiplexer 349-B sends the lower-half of the second operand 332-B to the flip-flop 366. The lower-half of the first operand 330-B and the lower-half of the second operand 332-B are each 8 bytes (or 64 bits).

At the permute control module 350-B, the decoded opcode 348-B is translated or remapped into control bytes 357-B, which are generic instructions. A unique control byte 357-B is generated for each of the 8 bytes 330-B, 332-B in the lower-half 304 of the datapath. To do so, the permute control module 350-B includes the lookup table (LUT) 351-B and the control byte selection multiplexer 359-B.

The lookup table (LUT) 351-B receives the decoded opcode 328-B, and the lower-half of the third operand 334-B, and based on these inputs, generates and outputs a set of control byte selection outputs 354-B.

The control byte selection multiplexer 359-B receives the set of control byte selection outputs 354-B and the decoded opcode 348-B. Based on the decoded opcode 348-B, the control byte selection multiplexer 359-B selects one of the set of control byte selection outputs 354-B and generates eight unique control bytes 357-B (i.e., one control byte corresponding to each byte in the lower-half 304 of the datapath). The control bytes 357-B correspond to various instructions that are to be performed to allow for the data movement required by those instructions. The control bytes 357-B determine which instruction will be performed with respect to each byte of the lower-half of the first operand 330-B and the lower-half of the second operand 332-B.

### Operation of Operand Read and Data Movement Instruction Lookup Pipeline Stage 313 During Two-Cycle Operation

FIG. 3C is a block diagram that illustrates elements and data paths of the operand read and data movement instruction lookup pipeline stage 313 of FIG. 3A that are involved when the particular operation being performed has two-cycle latency in accordance with some of the disclosed embodiments. FIG. 4B is a diagram that illustrates a two-cycle latency operation 420 including the processing performed at various pipeline stages 313, 316, 318 of the data movement module 260 in accordance with some of the disclosed embodiments. For two-cycle operations, only three pipeline stages 313, 316, 318 are used (i.e., separate pipeline stages 312, 314 are not required). Some instructions can be decoded as the operands are being delivered thereby effectively completing the operand read and instruction lookup operations simultaneously. This is represented in FIG. 3C by a combined operand read and data movement instruction lookup pipeline stage 313. Because the functions performed at 312 and 314 (of FIG. 3B) are effectively performed at the same time this allows one pipeline stage to be skipped or eliminated. For permute operations whose control information is entirely contained in the opcode and immediate value, the Lookup Tables (LUT) 352-A can be used during the operand read to determine control bytes 357-A for the byte swap pipeline stage 316 and processing can advance ahead to the byte swap pipeline stage 316 stage to begin computation. These permute operations can begin the byte swap stage 316 processing immediately after the combined operand read and data movement instruction lookup pipeline stage 313 and can be completed two-cycles after the combined operand read and data movement instruction lookup pipeline stage 313. Therefore these operations have a two-cycle latency. As illustrated in FIG. 4B, “simpler” instructions will require two processing cycles (i.e., have just a two-cycle latency) after the combined operand read and data movement instruction lookup pipeline stage 313. As such, this performance optimization can be used to eliminate one processing cycle for some of the instructions.

The multiplexer 343-A receives the decoded opcode 328-A directly from the decoder module 327-A, and then sends the decoded opcode 348-A to the lookup table (LUT) 352-A. The decoder 347-A can perform further decoding of the decoded opcode 328-A to generate decoded opcode 348-A.

The multiplexer 347-A receives the upper-half of the first operand 330-A from the first operand selection multiplexer 329-A, and sends the upper-half of the first operand 330-A to flip-flop 366, and the multiplexer 349-A receives the upper-half of the second operand 332-A from the second operand selection multiplexer 331-A, and sends the upper-half of the second operand 332-A to the flip-flop 366. The upper-half of the first operand 330-A and the upper-half of the second operand 332-A are each 8 bytes (or 64 bits).

When the particular operation being performed is a two-cycle latency operation, multiplexers 333-A, 333-B, and flip-flops 345-A, 346-A, 345-B, 346-B of FIG. 3A are not utilized.

The permute control module 350-A includes the lookup table (LUT) 352-A and the control byte selection multiplexer 359-A.

The lookup table (LUT) 352-A receives the decoded opcode 328-A, and generates a set of control byte selection outputs 355-A.

The control byte selection multiplexer 359-A receives the set of control byte selection outputs 355-A and the decoded opcode 348-A. Based on the decoded opcode 348-A, the control byte selection multiplexer 359-A selects one of the set of control byte selection outputs 355-A and generates eight unique control bytes 357-A (i.e., one control byte corresponding to each byte in the upper-half 304 of the datapath) that determine which instruction will be performed with respect to each byte of the upper-half of the first operand 330-A, and the upper-half of the second operand 332-A.

The multiplexer 343-B receives the decoded opcode 328-B directly from the decoder module 327-B, and then sends the decoded opcode 348-B to the lookup table (LUT) 352-B. The decoder 347-B can perform further decoding of the decoded opcode 328-B to generate decoded opcode 348-B.

The multiplexer 347-B receives the lower-half of the first operand 330-B from the first operand selection multiplexer 329-B, and sends the lower-half of the first operand 330-B to flip-flop 366, and the multiplexer 349-B receives the lower-half of the second operand 332-B from the second operand selection multiplexer 331-B, and sends the lower-half of the second operand 332-B to the flip-flop 366. The lower-half of the first operand 330-B and the lower-half of the second operand 332-B are each 8 bytes (or 64 bits).

When the particular operation being performed is a two-cycle latency operation, multiplexers 333-A, 333-B, and flip-flops 345-A, 346-A, 345-B, 346-B of FIG. 3A are not utilized.

The permute control module 350-B includes the lookup table (LUT) 352-B and the control byte selection multiplexer 359-B.

The lookup table (LUT) 352-B receives the decoded opcode 328-B, and generates a set of control byte selection outputs 355-B.

The control byte selection multiplexer 359-B receives the set of control byte selection outputs 355-B and the decoded opcode 348-B. Based on the decoded opcode 348-B, the control byte selection multiplexer 359-B selects one of the set of control byte selection outputs 355-B and generates eight unique control bytes 357-B (i.e., one control byte corresponding to each byte in the lower-half 304 of the datapath) that determine which instruction will be performed with respect to each byte of the lower-half of the first operand 330-B, and the lower-half of the second operand 332-B.

### Byte Swap Pipeline Stage

The byte swap pipeline stage 316 is the only place in the data movement module 260 of a crossbar switch module 240 where operand data crosses the 64-bit boundary 303 between the upper-half 304 and the lower-half 302 of data path. In other words, prior to the byte swap pipeline stage 316, other pipeline stages 312/314 or 313 of the data movement module 260 strictly process the upper-half portion and lower-half portion separately.

At the byte swap pipeline stage 316, sixteen bytes from the 128-bit operands 330 (i.e., 330-A, 330-B), 332 (i.e., 332-A, 332-B) can be swapped to any of sixteen output byte positions. The term “swapping” includes one or more of shifting, moving, re-ordering, shuffling or scrambling one or more of the selected bytes with respect to another one of the selected bytes to generate resultant bytes 375-1 . . . 375-16 of the byte swap stage intermediate result 375. As will be explained below, the byte swapper module 368 can select any byte from any one of the 64-bit operands 330-A, 330-B, 332-A, 332-B in any combination of 16 bytes, and shift, move, re-order, shuffle or scramble the selected bytes in any order to generate 16-byte output 375 arranged in (or permuted in) any order specified by the operation. The byte swapper module 368 can arbitrarily move any bytes of the operands 330, 332 from the upper-half 304 and the lower-half 302 of the data path or vice versa, but must move byte-sized chunks of operand data (and not bit size pieces of data). Each of the 16 selected bytes can come from any one of the 32 input bytes of the operands 330, 332. As will be explained in greater detail below, a portion of each of the sixteen control bytes 357-A, 357-B is used to select one of the 32 bytes from the operands 330-A, 330-B, 332-A, 332-B. Another portion of each of the sixteen control bytes 357-A, 357-B can then be used to optionally manipulate one of the sixteen selected operand bytes before passing the sixteen resultant bytes (375-1 . . . 375-16) of the byte swap stage intermediate result 375 to the next pipeline stage 318.

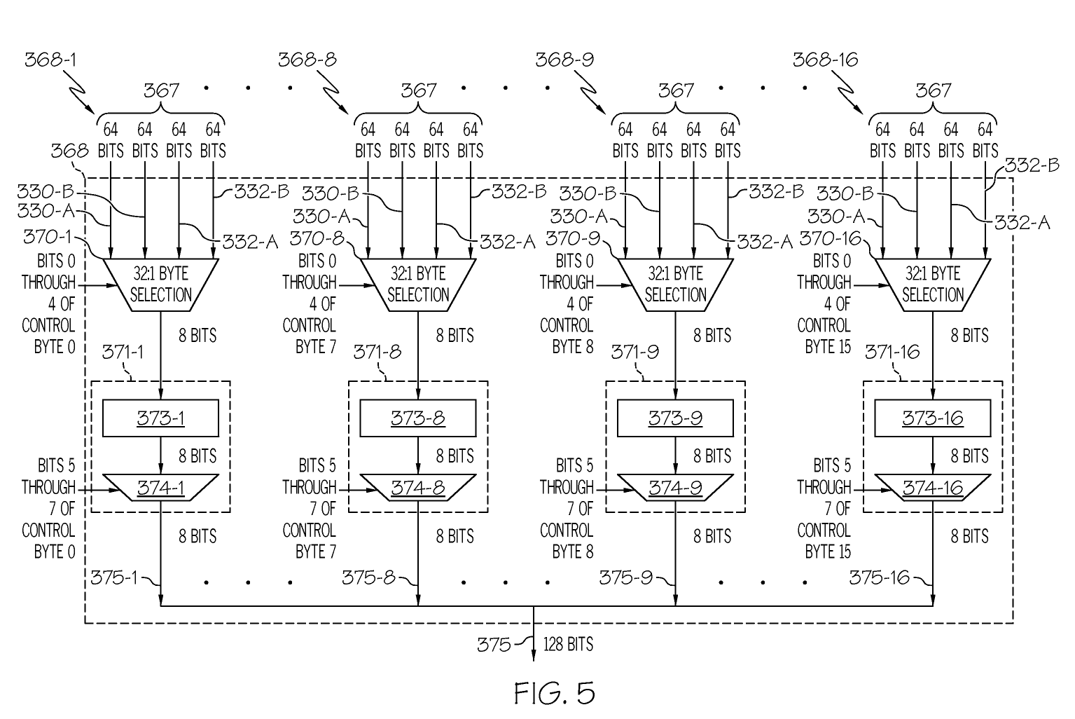

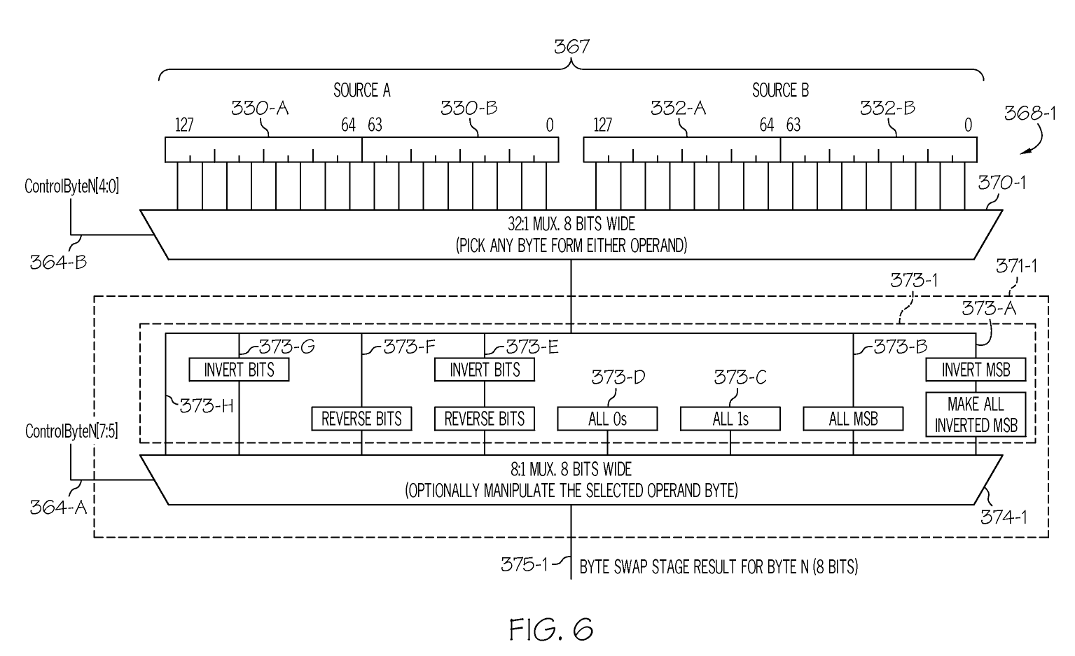

The byte swap pipeline stage 316 includes a plurality of flip-flops 361-A, 362-A, 361-B, 362-B, 366 and a byte swapper module 368. The flip-flop 361-A provides the decoded opcode 363-A to the next stage 318. Although not illustrated for sake of simplicity, further decoding of the decoded opcode 348-A can be performed to generate decoded opcode 363-A. The flip-flop 362-A provides the control bytes 357-A to the byte swapper module 368. The flip-flop 366 receives the following four 64-bit operands: the upper-half of the first operand 330-A, the upper-half of the second operand 332-A, the lower-half of the first operand 330-B and the lower-half of the second operand 332-B, which are represented collectively in FIGS. 3A-3C, 5 and 6 by reference number 367. Flip-flop 366 sends the operands 367 to each of the byte swapper sub-modules 368-1 . . . 368-16 of the byte swapper module 368. Each of the 64-bit operands 330-A, 330-B, 332-A, 332-B is 8 bytes, and therefore each of the byte swapper sub-modules 368-1 . . . 368-16 of the byte swapper module 368 receives an input 367 that includes 32 input bytes (256 bits) total. Each of the byte swapper sub-modules 368-1 . . . 368-16 of the byte swapper module 368 can then select any byte from any of the operands 330-A, 330-B, 332-A, 332-B and then, in some cases, optionally manipulate the selected byte before passing the resultant bytes 375-1 . . . 375-16 of the byte swap stage intermediate result 375 to the next pipeline stage 318. One implementation of the byte swapper module 368 will be described below with reference to FIGS. 5 and 6.

FIG. 5 is a block diagram that illustrates an exemplary implementation of a byte swapper module 368 of the data movement module 260 illustrated in FIG. 3A in accordance with some of the disclosed embodiments. The byte swapper module 368 includes sixteen byte swapper sub-modules 368-1 . . . 368-16. Each byte swapper sub-module 368-1 . . . 368-16 includes a byte selection multiplexer 370 and a corresponding byte manipulation module 371. Each of the sixteen byte selection multiplexers 370 is coupled to a corresponding one of the byte manipulation modules 371. It is noted that in FIG. 5, four of the sixteen byte swapper sub-modules 368-1 . . . 361-8, 361-9 . . . 368-16 (i.e., four of the byte selection multiplexers 370-1 . . . 370-8, 370-9 . . . 370-16 and four of the byte manipulation modules 371-1 . . . 371-8, 371-9 . . . 371-16) that make up the byte swapper module 368 are illustrated due to space limitations; however, the byte swapper module 368 actually includes sixteen byte swapper sub-modules 368-1 . . . 368-16 (i.e., sixteen byte selection multiplexers 370 and sixteen corresponding byte manipulation modules 371).

Each of the byte selection multiplexers 370-1 . . . 370-16 receives an input 367 that includes the first 128-bit operand 330 (i.e., the upper-half of the first operand 330-A and the lower-half of the first operand 330-B) and the second 128-bit operand 332 (i.e., the upper-half of the second operand 332-A and the lower-half of the second operand 332-B). Each of the byte selection multiplexers 370-1 . . . 370-16 are a 32:1 multiplexer that is 8 bits wide. Each of the byte selection multiplexers 370-1 . . . 370-16 uses the first five bits of one control byte N [4:0] (of the sixteen control bytes 357-A, 357-B corresponding to the operand) to select a byte from either the first or second operand 330, 332 as an input to its corresponding byte manipulation module 371.

Each of the byte manipulation modules 371-1 . . . 371-16 includes a post selection processor module 373-1 . . . 373-16 and a multiplexer 374-1 . . . 374-16.

FIG. 6 is a block diagram that illustrates an exemplary implementation of one byte swapper sub-module 368-1 that can be implemented in the byte swapper module 368 in accordance with some of the disclosed embodiments. The byte swapper sub-module 368-1 includes a byte selection multiplexer 370-1 coupled to a byte manipulation module 371-1. The byte manipulation module 371-1 includes a post selection processor module 373-1 and a 8-to-1 multiplexer 374-1. The post selection processor module 373-1 includes eight modules 373-A . . . 373-H where the selected operand byte (that was selected by the byte selection multiplexer 370-1) is processed a number of different ways. The eight modules 373-A . . . 373-H include a most significant bit inversion and replication module 373-A, a most significant bit converter module 373-B, an all ones bit converter module 373-C, an all zeroes bit converter module 373-D, a bit inversion and reversal module 373-E, a bit reversal module 373-F, a bit inversion module 373-G, and a passthrough module 373-H. The most significant bit inversion and replication module 373-A inverts the most significant, or leftmost, bit of the selected operand byte, and then replicates it across all 8 bits of the byte. The most significant bit converter module 373-B replicates the most significant, or leftmost bit of the selected operand byte and replicates it across all 8 bits of the byte. The all ones bit converter module 373-C does not operate on the selected operand byte, but instead outputs eight one bits (a logical 1 in each of the 8 bit positions). The all zeroes bit converter module 373-D does not operate on the selected operand byte, but instead outputs eight zero bits (a logical 0 in each of the 8 bit positions). The bit inversion and reversal module 373-E inverts the bits of the selected operand byte and then reverses the inverted bits. The bit reversal module 373-F reverses the order of the bits of the selected operand byte. The bit inversion module 373-G logically inverts each of the bits of the selected operand byte. The passthrough module 373-H directly sends the selected operand byte to the 8-to-1 multiplexer 374 without modifying it.

The processed operand bytes from each of the paths 373-A . . . 373-H are then sent to the 8-to-1 multiplexer 374-1, which uses another portion of its control byte 1 [7:5] to select one of the eight possible variations of the selected operand byte, and outputs it as a resultant byte 375-1 that can be anyone of the eight variations.

Each of the multiplexers 374-1 . . . 374-16 uses a portion of one of the sixteen control bytes N [7:5] to select one of the eight possible variations of the selected operand byte (that was selected by its corresponding 370-1 . . . 370-16), and outputs it as a resultant byte 375-1 . . . 375-16. The byte swapper module 368 outputs the sixteen resultant bytes 375-1 . . . 375-16 together as a 128-bit byte swap stage intermediate result 375 that is passed to flip-flop 376 of the bit swizzle pipeline stage 318.

### Bit Swizzle Pipeline Stage

Referring again to FIG. 3A, the bit swizzle pipeline stage 318 includes flip-flops 372-A, 372-B, 376, bit shifters 380-A, 380-B and multiplexers 390-A, 390-B.

The flip-flop 376 receives 128-bit byte swap stage intermediate result 375, and splits it into an upper-half 64-bit byte swap stage intermediate result 378-A that is provided to an upper-half of the bit swizzle pipeline stage 318, and a lower-half 64-bit byte swap stage intermediate result 378-B that is provided to a lower-half of the bit swizzle pipeline stage 318.

The upper-half of the bit swizzle pipeline stage 318 includes the flip-flop 372-A, the bit-shifter module 380-A, and the selection multiplexer 390-A.

The flip-flop 372-A receives the decoded opcode 377-A, and provides decoded opcode 377-A to the bit-shifter module 380-A and the selection multiplexer 390-A. Although not illustrated for sake of simplicity, further decoding of the decoded opcode 377-A can be performed to generate decoded opcode 377-A.

Bit shifting operations are performed with respect to upper-half of the byte swap stage intermediate result 378-A at bit-shifter module 380-A. The bit-shifter module 380-A receives the decoded opcode 377-A and the upper-half of the byte swap stage intermediate result 378-A, and based on these inputs, generates a bit-shifted version of the upper-half of the byte swap stage intermediate result 382-A. When the upper-half of the byte swap stage intermediate result 378-A is provided to bit-shifter module 380-A, the bit-shifter module 380-A can perform bit shifting if instructed to by control byte decoded opcode 377-A. In one embodiment, the bit-shifter module 380-A includes eight bit shifter sub-modules (not illustrated) that are each eight bits wide. Each bit shifter sub-module of the bit-shifter module 380-A can shift or rotate the bits in any particular byte of the upper-half of the byte swap stage intermediate result 378-A by up to a maximum of 7 bit positions on byte, word, double word or quad word boundaries depending on information specified in the decoded opcode 363-A. Operating independently, the byte wide shifters shift or rotate the result on byte boundaries. They can also be configured to operate in pairs or larger groups to shift or rotate by up to 7 bits on word, double-word or quad-word boundaries.

The decoded opcode 377-A is used at the selection multiplexer 390-A to control which of the upper-half of the byte swap stage intermediate result 378-A and the bit-shifted version of the upper-half of the byte swap stage intermediate result 382-A are output by the selection multiplexer 390-A.

An unshifted version of the upper-half of the byte swap stage intermediate result 378-A is also provided to the selection multiplexer 390-A, which effectively allows bit shifting operations to be ignored when the selection multiplexer 390-A is instructed to select the upper-half of the byte swap stage intermediate result 378-A (e.g., so that no bit shifting is performed with respect to the upper-half of the byte swap stage intermediate result 378-A). Alternatively, when decoded opcode 377-A indicates that no bit shifting operation is to be performed on the upper-half of the byte swap stage intermediate result 378-A, the selection multiplexer 390-A simply passes the upper-half of the byte swap stage intermediate result 378-A as the upper-half result 392-A without shifting any of its bits. In this case, the upper-half of the byte swap stage intermediate result 378-A is simply passed through selection multiplexer 390-A without any bit shifting being performed.

Thus, the selection multiplexer 390-A receives the decoded opcode 377-A, the upper-half of the byte swap stage intermediate result 378-A and the bit-shifted version of the upper-half of the byte swap stage intermediate result 382-A, and based on these inputs, selects either the upper-half of the byte swap stage intermediate result 378-A or the bit-shifted version of the upper-half of the byte swap stage intermediate result 382-A as the upper-half result 392-A. The upper-half result 392-A can be sent to the first operand selection multiplexer 329-A, the second operand selection multiplexer 331-A, the third operand selection multiplexer 333-A and/or to a bypass network (not illustrated).

The lower-half of the bit swizzle pipeline stage 318 includes the flip-flop 372-B, the bit-shifter module 380-B, and the selection multiplexer 390-B.

The flip-flop 372-B receives the decoded opcode 377-B, and provides decoded opcode 377-B to the bit-shifter module 380-B and the selection multiplexer 390-B. Although not illustrated for sake of simplicity, further decoding of the decoded opcode 377-B can be performed to generate decoded opcode 377-B.

Bit shifting operations are performed with respect to lower-half of the byte swap stage intermediate result 378-B at bit-shifter module 380-B. The bit-shifter module 380-B receives the decoded opcode 377-B and the lower-half of the byte swap stage intermediate result 378-B, and based on these inputs, may generate the bit-shifted version of the lower-half of the byte swap stage intermediate result 382-B. When the lower-half of the byte swap stage intermediate result 378-B is provided to bit-shifter module 380-B, the bit-shifter module 380-B can perform bit shifting as instructed by control byte decoded opcode 377-B. In one embodiment, the bit-shifter module 380-B includes eight bit shifter sub-modules (not illustrated) that are each eight bits wide. Each bit shifter sub-module of the bit-shifter module 380-B can shift or rotate the bits in any particular byte of the lower-half of the byte swap stage intermediate result 378-B by up to a maximum of 7 bit positions on byte, word, double word or quad word boundaries depending on information specified in the decoded opcode 377-B. Operating independently, the byte wide shifters shift or rotate on byte boundaries. They can also be configured to operate in pairs or larger groups to shift or rotate by up to 7 bits on word, double-word or quad-word boundaries.

The decoded opcode 377-B is used at the selection multiplexer 390-B to control which of the lower-half of the byte swap stage intermediate result 378-B and the bit-shifted version of the lower-half of the byte swap stage intermediate result 382-B are output by the selection multiplexer 390-B.

An unshifted version of the lower-half of the byte swap stage intermediate result 378-B is also provided to the selection multiplexer 390-B, which effectively allows bit shifting operations to be ignored when the selection multiplexer 390-B is instructed to select the lower-half of the byte swap stage intermediate result 378-B (e.g., so that no bit shifting is performed with respect to the lower-half of the byte swap stage intermediate result 378-B). Alternatively, when decoded opcode 377-B indicates that no bit shifting operation is to be performed on the lower-half of the byte swap stage intermediate result 378-B, the selection multiplexer 390-B simply passes the lower-half of the byte swap stage intermediate result 378-B as the lower-half result 392-B without shifting any of its bits. In this case, the lower-half of the byte swap stage intermediate result 378-B is simply passed through selection multiplexer 390-B without any bit shifting being performed.

The selection multiplexer 390-B receives the decoded opcode 377-B, the lower-half of the byte swap stage intermediate result 378-B and the bit-shifted version of the lower-half of the byte swap stage intermediate result 382-B, and based on these inputs, selects either the lower-half of the byte swap stage intermediate result 378-B or the bit-shifted version of the lower-half of the byte swap stage intermediate result 382-B as the lower-half result 392-B. The lower-half result 392-B can be sent to the first operand selection multiplexer 329-B, the second operand selection multiplexer 331-B, the third operand selection multiplexer 333-B and/or to a bypass network (not illustrated).

Thus, the byte swap pipeline stage 316 can be used to manipulate or permute bytes of operands 330-A, 332-A, 330-B, 332-B, and the bit swizzle pipeline stage 318 can then be used to shift the individual bits that make up each byte of the 64-bit byte swap stage intermediate results 378-A, 378-B, which can allow many different instructions to be performed at the data movement module 260.

### EXAMPLES

Two non-limiting examples of such instructions will now be described for context; however, it will be appreciated that many, many other instruction can also be performed using the architecture described above.

### Example 1

### Shift Right Arithmetic Double-Word by 12 Bits

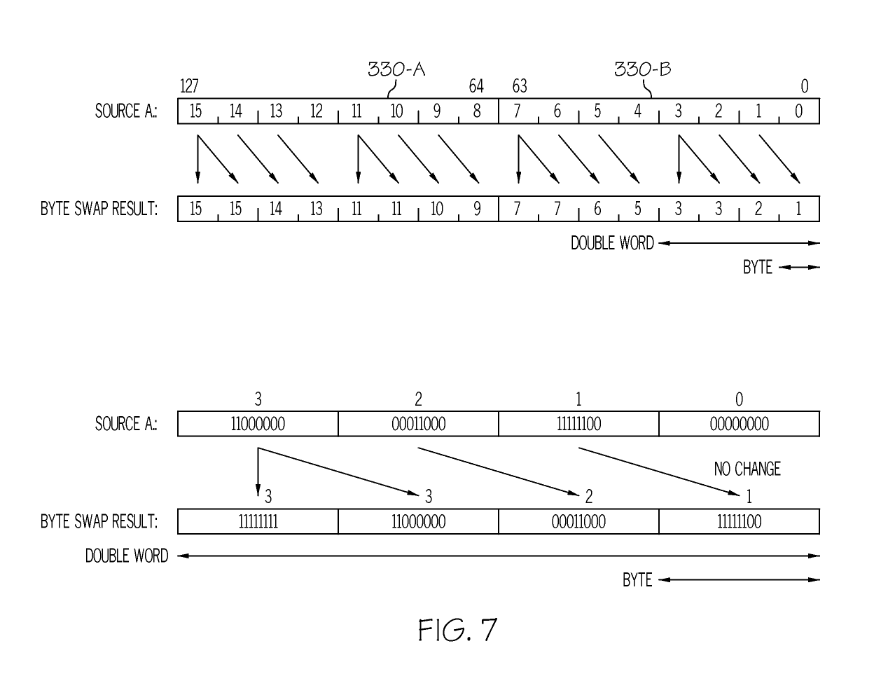

FIG. 7 is a diagram that illustrates processing of a 16-byte first operand 330-A, 330-B during a shift right arithmetic double-word by 12 bits operation (FPSRAD Imm=12) performed by the byte swapper module 368 in accordance with an exemplary implementation of one possible instruction of the disclosed embodiments.

The first operand 330-A, 330-B will be received by each byte selection multiplexer 370-1 . . . 370-16. The first operand 330-A, 330-B includes sixteen bytes 0 . . . 15. The byte selection multiplexers 370-1 . . . 370-16 of the byte swapper module 368 will each receive one of the control bytes 0 . . . 15.

Bits 0 . . . 4 of control byte zero will indicate that byte swapper sub-module 368-1 is to select byte 1 from the lower-half of the first operand 330-B as byte 0, and bits 5 . . . 7 of control byte zero will indicate that corresponding byte manipulation module 371-1 should not make any changes to byte 1 from the lower-half of the first operand 330-B. Thus, byte 1 from the lower-half of the first operand 330-B will become byte 0 375-1 of the 16-byte byte swap stage intermediate result 375.

Bits 0 . . . 4 of control byte one will indicate that byte swapper sub-module 368-2 is to select byte 2 from the lower-half of the first operand 330-B as byte 1, and bits 5 . . . 7 of control byte one will indicate that corresponding byte manipulation module 371-2 should not make any changes to byte 2 from the lower-half of the first operand 330-B. Thus, byte 2 from the lower-half of the first operand 330-B will become byte 1 375-2 of the 16-byte byte swap stage intermediate result 375.

Bits 0 . . . 4 of control byte two will indicate that byte swapper sub-module 368-3 is to select byte 3 from the lower-half of the first operand 330-B as byte 2, and bits 5 . . . 7 of control byte two will indicate that corresponding byte manipulation module 371-3 should not make any changes to byte 3 from the lower-half of the first operand 330-B. Thus, byte 3 from the lower-half of the first operand 330-B will become byte 3 375-3 of the 16-byte byte swap stage intermediate result 375.

Bits 0 . . . 4 of control byte three will indicate that byte swapper sub-module 368-4 should also select byte 3 from the lower-half of the first operand 330-B as byte 3, and bits 5 . . . 7 of control byte three will indicate that corresponding byte manipulation module 371-4 should change byte 3 from the lower-half of the first operand 330-B by replicating it's most significant (or leftmost) bit to all the bit positions, which in this case would yield all most significant bits 11111111 (i.e., all ones). Thus, byte three 375-3 of the 16-byte byte swap stage intermediate result 375 will be all most significant bits 11111111 (i.e., all ones).

Bits 0 . . . 4 of control byte four will indicate that byte swapper sub-module 368-5 is to select byte five from the lower-half of the first operand 330-B as byte four, and bits 5 . . . 7 of control byte four will indicate that corresponding byte manipulation module 371-5 should not make any changes to byte five from the lower-half of the first operand 330-B. Thus, byte five from the lower-half of the first operand 330-B will become byte four 375-4 of the 16-byte byte swap stage intermediate result 375.

Bits 0 . . . 4 of control byte five will indicate that byte swapper sub-module 368-6 is to select byte six from the lower-half of the first operand 330-B as byte five, and bits 5 . . . 7 of control byte five will indicate that corresponding byte manipulation module 371-6 should not make any changes to byte six from the lower-half of the first operand 330-B. Thus, byte six from the lower-half of the first operand 330-B will become byte five 375-5 of the 16-byte byte swap stage intermediate result 375.

Bits 0 . . . 4 of control byte six will indicate that byte swapper sub-module 368-7 is to select byte seven from the lower-half of the first operand 330-B as byte six, and bits 5 . . . 7 of control byte six will indicate that corresponding byte manipulation module 371-7 should not make any changes to byte seven from the lower-half of the first operand 330-B. Thus, byte seven from the lower-half of the first operand 330-B will become byte six 375-6 of the 16-byte byte swap stage intermediate result 375.

Bits 0 . . . 4 of control byte seven will indicate that byte swapper sub-module 368-8 should also select byte seven from the lower-half of the first operand 330-B as byte seven, and bits 5 . . . 7 of control byte three will indicate that corresponding byte manipulation module 371-8 should change byte seven from the lower-half of the first operand 330-B to replicate the most significant (or leftmost) bit into all bit positions resulting in either 11111111 (all ones) or 00000000 (all zeros) depending on the value of the most significant bit of byte seven from the lower-half of the first operand 330-B (which is not specified in FIG. 7). Thus, byte seven 375-7 of the 16-byte byte swap stage intermediate result 375 will be all most significant bits 11111111 (i.e., all ones) or 00000000 (all 0s).

Bits 0 . . . 4 of control byte eight will indicate that byte swapper sub-module 368-9 is to select byte nine from the upper-half of the first operand 330-A as byte eight, and bits 5 . . . 7 of control byte eight will indicate that corresponding byte manipulation module 371-9 should not make any changes to byte nine from the upper-half of the first operand 330-A. Thus, byte nine from the upper-half of the first operand 330-A will become byte eight 375-8 of the 16-byte byte swap stage intermediate result 375.

Bits 0 . . . 4 of control byte nine will indicate that byte swapper sub-module 368-10 is to select byte ten from the upper-half of the first operand 330-A as byte nine, and bits 5 . . . 7 of control byte nine will indicate that corresponding byte manipulation module 371-10 should not make any changes to byte ten from the upper-half of the first operand 330-A. Thus, byte ten from the upper-half of the first operand 330-A will become byte nine 375-9 of the 16-byte byte swap stage intermediate result 375.

Bits 0 . . . 4 of control byte ten will indicate that byte swapper sub-module 368-11 is to select byte eleven from the upper-half of the first operand 330-A as byte ten, and bits 5 . . . 7 of control byte ten will indicate that corresponding byte manipulation module 371-11 should not make any changes to byte eleven from the upper-half of the first operand 330-A. Thus, byte eleven from the upper-half of the first operand 330-A will become byte ten 375-10 of the 16-byte byte swap stage intermediate result 375.

Bits 0 . . . 4 of control byte eleven will indicate that byte swapper sub-module 368-12 should also select byte eleven from the upper-half of the first operand 330-A as byte eleven, and bits 5 . . . 7 of control byte eleven will indicate that corresponding byte manipulation module 371-12 should change byte eleven from the upper-half of the first operand 330-A to replicate the most significant (or leftmost) bit into all bit positions resulting in either 11111111 (all ones) or 00000000 (all zeros) depending on the value of the most significant bit of byte seven from the upper-half of the first operand 330-A (which is not specified in FIG. 7). Thus, byte eleven 375-11 of the 16-byte byte swap stage intermediate result 375 will be all most significant bits 11111111 (i.e., all ones) or 00000000 (all 0s).

Bits 0 . . . 4 of control byte twelve will indicate that byte swapper sub-module 368-13 is to select byte thirteen from the upper-half of the first operand 330-A as byte twelve, and bits 5 . . . 7 of control byte twelve will indicate that corresponding byte manipulation module 371-13 should not make any changes to byte thirteen from the upper-half of the first operand 330-A. Thus, byte thirteen from the upper-half of the first operand 330-A will become byte twelve 375-12 of the 16-byte byte swap stage intermediate result 375.

Bits 0 . . . 4 of control byte thirteen will indicate that byte swapper sub-module 368-14 is to select byte fourteen from the upper-half of the first operand 330-A as byte thirteen, and bits 5 . . . 7 of control byte thirteen will indicate that corresponding byte manipulation module 371-14 should not make any changes to byte fourteen from the upper-half of the first operand 330-A. Thus, byte fourteen from the upper-half of the first operand 330-A will become byte thirteen 375-13 of the 16-byte byte swap stage intermediate result 375.

Bits 0 . . . 4 of control byte fourteen will indicate that byte swapper sub-module 368-15 is to select byte fifteen from the upper-half of the first operand 330-A as byte fourteen, and bits 5 . . . 7 of control byte fourteen will indicate that corresponding byte manipulation module 371-15 should not make any changes to byte fifteen from the upper-half of the first operand 330-A. Thus, byte fifteen from the upper-half of the first operand 330-A will become byte fourteen 375-14 of the 16-byte byte swap stage intermediate result 375.

Bits 0 . . . 4 of control byte fifteen will indicate that byte swapper sub-module 368-16 should also select byte fifteen from the upper-half of the first operand 330-A as byte fifteen, and bits 5 . . . 7 of control byte three will indicate that corresponding byte manipulation module 371-16 should change byte fifteen from the upper-half of the first operand 330-A to replicate the most significant (or leftmost) bit into all bit positions resulting in either 11111111 (all ones) or 00000000 (all zeros) depending on the value of the most significant bit of byte seven from the upper-half of the first operand 330-A (which is not specified in FIG. 7. Thus, byte fifteen 375-15 of the 16-byte byte swap stage intermediate result 375 will be all most significant bits 11111111 (i.e., all ones) or 00000000 (all 0s).

Although not illustrated, the byte swap stage intermediate result 375 will be split at the flip-flop 376, and the bit-shifter module 380-A will shift the upper-half of the byte swap stage intermediate result 378-A to the right by 4 more bits to generate the bit-shifted version of the upper-half of the byte swap stage intermediate result 382-A which will be selected as the upper-half result 392-A, and the bit-shifter module 380-B will shift the lower-half of the byte swap stage intermediate result 378-B to the right by 4 more bits to generate the bit-shifted version of the lower-half of the byte swap stage intermediate result 382-B which will be selected as the lower-half result 392-B. Therefore the 12 bit shift required by the instruction is accomplished by shifting by 8 bits (or one byte) in the byte swap pipeline stage 316 and a further 4 bits in the bit swizzle pipeline stage 318.

### Example 2

### Unpack and Interleave Low Double Words

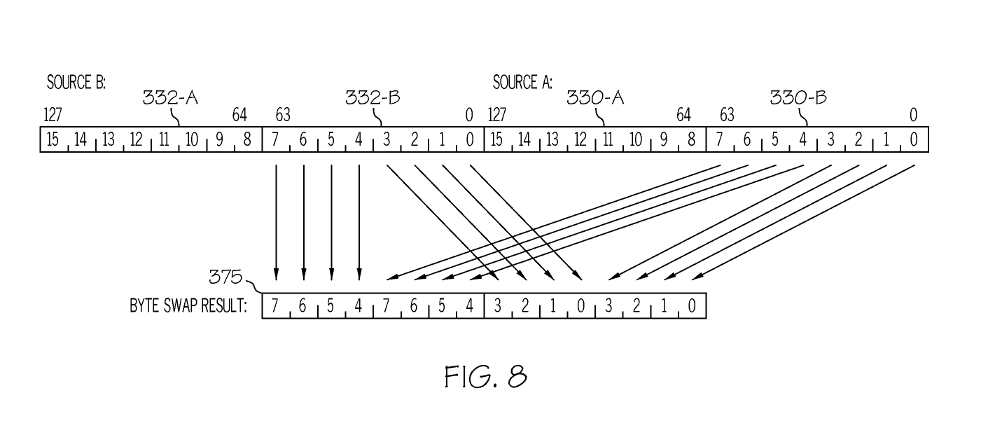

FIG. 8 is a diagram that illustrates processing of a 16-byte first operand 330-A, 330-B and a 16-byte second operand 332-A, 332-B during an unpack and interleave low double words operation (FKPUNPKLDQ) performed by the byte swapper module 368 in accordance with an exemplary implementation of one possible instruction of the disclosed embodiments.

The first operand 330-A, 330-B and the second operand 332-A, 332-B will be received by each byte selection multiplexer 370-1 . . . 370-16. The operands both include sixteen bytes 0 . . . 15. The byte selection multiplexers 370-1 . . . 370-16 of the byte swapper module 368 will each receive one of the control bytes 0 . . . 15.

Bits 0 . . . 4 of control byte zero will indicate that byte swapper sub-module 368-1 is to select byte zero from the lower-half of the first operand 330-B as byte zero, and bits 5 . . . 7 of control byte zero will indicate that corresponding byte manipulation module 371-1 should not make any changes to byte zero from the lower-half of the first operand 330-B. Thus, byte zero from the lower-half of the first operand 330-B will become byte zero 375-1 of the 16-byte byte swap stage intermediate result 375.

Bits 0 . . . 4 of control byte one will indicate that byte swapper sub-module 368-2 is to select byte one from the lower-half of the first operand 330-B as byte one, and bits 5 . . . 7 of control byte one will indicate that corresponding byte manipulation module 371-2 should not make any changes to byte one from the lower-half of the first operand 330-B. Thus, byte one from the lower-half of the first operand 330-B will become byte one 375-2 of the 16-byte byte swap stage intermediate result 375.

Bits 0 . . . 4 of control byte two will indicate that byte swapper sub-module 368-3 is to select byte two from the lower-half of the first operand 330-B as byte two, and bits 5 . . . 7 of control byte two will indicate that corresponding byte manipulation module 371-3 should not make any changes to byte two from the lower-half of the first operand 330-B. Thus, byte two from the lower-half of the first operand 330-B will become byte two 375-3 of the 16-byte byte swap stage intermediate result 375.

Bits 0 . . . 4 of control byte three will indicate that byte swapper sub-module 368-4 is to select byte three from the lower-half of the first operand 330-B as byte three, and bits 5 . . . 7 of control byte three will indicate that corresponding byte manipulation module 371-4 should not make any changes to byte three from the lower-half of the first operand 330-B. Thus, byte three from the lower-half of the first operand 330-B will become byte three 375-4 of the 16-byte byte swap stage intermediate result 375.

Bits 0 . . . 4 of control byte four will indicate that byte swapper sub-module 368-5 is to select byte zero from the lower-half of the second operand 332-B as byte four, and bits 5 . . . 7 of control byte four will indicate that corresponding byte manipulation module 371-5 should not make any changes to byte zero from the lower-half of the second operand 332-B. Thus, byte zero from the lower-half of the second operand 332-B will become byte four 375-5 of the 16-byte byte swap stage intermediate result 375.

Bits 0 . . . 4 of control byte five will indicate that byte swapper sub-module 368-6 is to select byte one from the lower-half of the second operand 332-B as byte five, and bits 5 . . . 7 of control byte five will indicate that corresponding byte manipulation module 371-6 should not make any changes to byte one from the lower-half of the second operand 332-B. Thus, byte one from the lower-half of the second operand 332-B will become byte five 375-6 of the 16-byte byte swap stage intermediate result 375.

Bits 0 . . . 4 of control byte six will indicate that byte swapper sub-module 368-7 is to select byte two from the lower-half of the second operand 332-B as byte six, and bits 5 . . . 7 of control byte six will indicate that corresponding byte manipulation module 371-7 should not make any changes to byte two from the lower-half of the second operand 332-B. Thus, byte two from the lower-half of the second operand 332-B will become byte six 375-7 of the 16-byte byte swap stage intermediate result 375.

Bits 0 . . . 4 of control byte seven will indicate that byte swapper sub-module 368-8 is to select byte three from the lower-half of the second operand 332-B as byte seven, and bits 5 . . . 7 of control byte seven will indicate that corresponding byte manipulation module 371-8 should not make any changes to byte three from the lower-half of the second operand 332-B. Thus, byte three from the lower-half of the second operand 332-B will become byte seven 375-8 of the 16-byte byte swap stage intermediate result 375.

Bits 0 . . . 4 of control byte eight will indicate that byte swapper sub-module 368-9 is to select byte four from the lower-half of the first operand 330-B as byte eight, and bits 5 . . . 7 of control byte eight will indicate that corresponding byte manipulation module 371-9 should not make any changes to byte four from the lower-half of the first operand 330-B. Thus, byte four from the lower-half of the first operand 330-B will become byte eight 375-9 of the 16-byte byte swap stage intermediate result 375.

Bits 0 . . . 4 of control byte nine will indicate that byte swapper sub-module 368-10 is to select byte five from the lower-half of the first operand 330-B as byte nine, and bits 5 . . . 7 of control byte nine will indicate that corresponding byte manipulation module 371-10 should not make any changes to byte five from the lower-half of the first operand 330-B. Thus, byte five from the lower-half of the first operand 330-B will become byte nine 375-10 of the 16-byte byte swap stage intermediate result 375.

Bits 0 . . . 4 of control byte ten will indicate that byte swapper sub-module 368-11 is to select byte six from the lower-half of the first operand 330-B as byte ten, and bits 5 . . . 7 of control byte ten will indicate that corresponding byte manipulation module 371-11 should not make any changes to byte six from the lower-half of the first operand 330-B. Thus, byte six from the lower-half of the first operand 330-B will become byte ten 375-11 of the 16-byte byte swap stage intermediate result 375.

Bits 0 . . . 4 of control byte eleven will indicate that byte swapper sub-module 368-12 is to select byte seven from the lower-half of the first operand 330-B as byte eleven, and bits 5 . . . 7 of control byte eleven will indicate that corresponding byte manipulation module 371-12 should not make any changes to byte seven from the lower-half of the first operand 330-B. Thus, byte seven from the lower-half of the first operand 330-B will become byte eleven 375-12 of the 16-byte byte swap stage intermediate result 375.

Bits 0 . . . 4 of control byte twelve will indicate that byte swapper sub-module 368-13 is to select byte four from the lower-half of the second operand 332-B as byte twelve, and bits 5 . . . 7 of control byte twelve will indicate that corresponding byte manipulation module 371-13 should not make any changes to byte four from the lower-half of the second operand 332-B. Thus, byte four from the lower-half of the second operand 332-B will become byte twelve 375-13 of the 16-byte byte swap stage intermediate result 375.

Bits 0 . . . 4 of control byte thirteen will indicate that byte swapper sub-module 368-14 is to select byte five from the lower-half of the second operand 332-B as byte thirteen, and bits 5 . . . 7 of control byte thirteen will indicate that corresponding byte manipulation module 371-14 should not make any changes to byte five from the lower-half of the second operand 332-B. Thus, byte five from the lower-half of the second operand 332-B will become byte thirteen 375-14 of the 16-byte byte swap stage intermediate result 375.

Bits 0 . . . 4 of control byte fourteen will indicate that byte swapper sub-module 368-15 is to select byte six from the lower-half of the second operand 332-B as byte fourteen, and bits 5 . . . 7 of control byte fourteen will indicate that corresponding byte manipulation module 371-15 should not make any changes to byte six from the lower-half of the second operand 332-B. Thus, byte six from the lower-half of the second operand 332-B will become byte fourteen 375-15 of the 16-byte byte swap stage intermediate result 375.

Bits 0 . . . 4 of control byte fifteen will indicate that byte swapper sub-module 368-16 is to select byte seven from the lower-half of the second operand 332-B as byte fifteen, and bits 5 . . . 7 of control byte fifteen will indicate that corresponding byte manipulation module 371-16 should not make any changes to byte seven from the lower-half of the second operand 332-B. Thus, byte seven from the lower-half of the second operand 332-B will become byte fifteen 375-16 of the 16-byte byte swap stage intermediate result 375.

Bytes zero 375-1 through fifteen 375-16 are used to create the 16-byte byte swap stage intermediate result 375. Although not illustrated, the byte swap stage intermediate result 375 will be split at the flip-flop 376. The selection multiplexer 390-A will select the upper-half of the byte swap stage intermediate result 378-A as the upper-half result 392-A and the selection multiplexer 390-B will select the lower-half of the byte swap stage intermediate result 378-B as the lower-half result 392-B. In other words, no bit level manipulation is necessary with this particular instruction—the upper-half of the byte swap stage intermediate result 378-A and the lower-half of the byte swap stage intermediate result 378-B will pass through bit swizzle pipeline stage 318 unchanged.

As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node).

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. In addition, certain terminology may also be used in the following description for the purpose of reference only, and thus are not intended to be limiting. For example, terms such as “first,” “second,” and other such numerical terms referring to elements or features do not imply a sequence or order unless clearly indicated by the context.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for executing an instruction at a processor to perform data manipulation with respect to one or more split-operands, the method comprising:
receiving upper-halves of the one or more split-operands comprising an upper-half of a first operand and an upper-half of a second operand, and lower-halves of the one or more split-operands comprising a lower-half of the first operand and a lower-half of the second operand;
decoding an upper-half of an operational code and a lower-half of the operational code to generate an upper-half decoded operational code, and decoding a lower-half of the operational code to generate a lower-half decoded operational code;
generating a first set of control bytes and a second set of control bytes that correspond to the instruction; and
swapping, based on the first set of control bytes and the second set of control bytes, one or more bytes selected from the upper-half of the first operand, the upper-half of the second operand, the lower-half of the first operand and the lower-half of the second operand.

2. A method according to claim 1, wherein generating a first set of control bytes and a second set of control bytes that correspond to the instruction, comprises:
generating a first set of control bytes that correspond to the instruction that is to be performed with respect to each byte of the upper-half of the first operand and the upper-half of the second operand, wherein each control byte of the first set of control bytes determines which instruction will be performed with respect to each corresponding byte of the upper-half of the first operand and the upper-half of the second operand; and
generating a second set of control bytes that correspond to the instruction that is to be performed with respect to each byte of the lower-half of the first operand and the lower-half of the second operand, wherein each control byte of the second set of control bytes determines which instruction will be performed with respect to each corresponding byte of the lower-half of the first operand and the lower-half of the second operand.

3. A method according to claim 1, wherein generating a first set of control bytes and a second set of control bytes that correspond to the instruction comprises:
translating the upper-half decoded operational code into a first set of control byte selection outputs, and selecting, based on the upper-half decoded operational code, one of the first set of control byte selection outputs as the first set of control bytes that correspond to each byte of the upper-half of the first operand and the upper-half of the second operand; and
translating the lower-half decoded operational code into a second set of control byte selection outputs, and selecting, based on the lower-half decoded operational code, one of the second set of control byte selection outputs as the second set of control bytes that correspond to each byte of the lower-half of the first operand and the lower-half of the second operand.

4. A method according to claim 1, wherein the upper-halves of the one or more split-operands further comprise an upper-half of a third operand, and wherein the lower-halves of the one or more split-operands further comprise a lower-half of the third operand, and wherein generating a first set of control bytes and a second set of control bytes that correspond to the instruction, comprises:
translating first inputs into a first set of control byte selection outputs, wherein the first inputs comprise the upper-half decoded operational code, and the upper-half of the third operand, and selecting, based on the upper-half decoded operational code, one of the first set of control byte selection outputs as the first set of control bytes that correspond to each byte of the upper-half of the first operand and the upper-half of the second operand; and
translating second inputs into a second set of control byte selection outputs, wherein the second inputs comprise the lower-half decoded operational code, and the lower-half of the third operand, and selecting, based on the lower-half decoded operational code, one of the second set of control byte selection outputs as the second set of control bytes that correspond to each byte of the lower-half of the first operand and the lower-half of the second operand.

5. A method according to claim 1, further comprising:
selecting, based on some of the bits of each of the first set of control bytes and the second set of control bytes, selected bytes from one or more of the upper-half of the first operand, the upper-half of the second operand, the lower-half of the first operand and the lower-half of the second operand; and
wherein swapping, based on the first set of control bytes and the second set of control bytes, one or more bytes selected from the upper-half of the first operand, the upper-half of the second operand, the lower-half of the first operand and the lower-half of the second operand, comprises:
swapping, based on the first set of control bytes and the second set of control bytes, one or more of the selected bytes with another one of the selected bytes to generate resultant bytes of a byte swap stage intermediate result that comprises the resultant bytes arranged in the order specified by the permute operation according to the first set of control bytes and the second set of control bytes.

6. A method according to claim 5, wherein selecting, based on some of the bits of each of the first set of control bytes and the second set of control bytes, selected bytes from one or more of the upper-half of the first operand, the upper-half of the second operand, the lower-half of the first operand and the lower-half of the second operand, comprises:
for each particular one of the control bytes:
selecting, based on some of the bits of that particular control byte, a selected byte from one of the upper-half of the first operand, the upper-half of the second operand, the lower-half of the first operand and the lower-half of the second operand; and
wherein swapping, comprises:
manipulating bits of the selected byte to generate manipulated versions of the selected byte; and
selecting, based on other bits of the particular control byte, either the selected byte or one of the manipulated versions of the selected byte as one of the resultant bytes of the byte swap stage intermediate result.

7. A method according to claim 1, wherein the swapping includes one or more of shifting, moving, re-ordering, shuffling or scrambling one or more of the selected bytes with respect to another one of the selected bytes to generate resultant bytes of the byte swap stage intermediate result.

8. A method according to claim 1, further comprising:
splitting the byte swap stage intermediate result into an upper-half of the byte swap stage intermediate result, and a lower-half of the byte swap stage intermediate result;
shifting bits of the upper-half of the byte swap stage intermediate result per an instruction in the upper-half of the decoded opcode to generate a bit-shifted version of the upper-half of the byte swap stage intermediate result;
shifting bits of the lower-half of the byte swap stage intermediate result per an instruction in the lower-half of the decoded opcode to generate a bit-shifted version of the lower-half of the byte swap stage intermediate result;
selecting, based on the upper-half of the decoded opcode, either the upper-half of the byte swap stage intermediate result or the bit-shifted version of the upper-half of the byte swap stage intermediate result as an upper-half result; and
selecting, based on the lower-half of the decoded opcode, either the lower-half of the byte swap stage intermediate result or the bit-shifted version of the lower-half of the byte swap stage intermediate result as a lower-half result.

9. A method according to claim 8, wherein shifting bits of the upper-half of the byte swap stage intermediate result per an instruction in the upper-half of the decoded opcode to generate a bit-shifted version of the upper-half of the byte swap stage intermediate result, comprises:
shifting or rotating bits in any particular byte of the upper-half of the byte swap stage intermediate result by up to a maximum of 7 bit positions on byte, word, double word or quad word boundaries based on information specified in the upper-half of the decoded opcode to generate the bit-shifted version of the upper-half of the byte swap stage intermediate result, and
wherein shifting bits of the lower-half of the byte swap stage intermediate result per an instruction in the lower-half of the decoded opcode to generate a bit-shifted version of the lower-half of the byte swap stage intermediate result, comprises:
shifting or rotating bits in any particular byte of the lower-half of the byte swap stage intermediate result by up to a maximum of 7 bit positions on byte, word, double word or quad word boundaries based on information specified in the lower-half of the decoded opcode to generate the bit-shifted version of the lower-half of the byte swap stage intermediate result.

10. A method according to claim 1, wherein the instruction executed at the processor with respect to the one or more split-operands comprises one or more of:
a vectored conditional move instruction;
a pack instruction;
an unpack instruction;
an extract instruction;
a rotate instruction;
a shift instruction; and
any other instruction in which operand data is manipulated, shifted, moved, re-ordered, shuffled or scrambled.

11. In a crossbar switch module of a microprocessor, a data movement module configured to execute an instruction to perform data manipulation with respect to one or more split-operands, the data movement module comprising:
an operand read pipeline stage and data movement instruction lookup pipeline stage comprising:
an upper-half portion configured to receive an upper-half of an operational code and upper-halves of the one or more split-operands comprising an upper-half of a first operand and an upper-half of a second operand, and to generate a first set of control bytes that correspond to the instruction that is to be performed with respect to each byte of the upper-half of the first operand and the upper-half of the second operand; and
a lower-half portion configured to receive a lower-half of the operational code and lower-halves of the one or more split-operands comprising a lower-half of the first operand and a lower-half of the second operand, and to generate a second set of control bytes that correspond to the instruction that is to be performed with respect to each byte of the lower-half of the first operand and the lower-half of the second operand;
a byte swap pipeline stage configured to swap, based on the first set of control bytes and the second set of control bytes, one or more bytes selected from the upper-half of the first operand, the upper-half of the second operand, the lower-half of the first operand and the lower-half of the second operand.

12. A data movement module according to claim 11, wherein the upper-half of the operand read pipeline stage comprises:
an upper-half opcode decoder module configured to receive and to decode the upper-half of the operational code to generate an upper-half decoded operational code; and
wherein the lower-half of the operand read pipeline stage of the data movement module, comprises:
a lower-half opcode decoder module configured to receive and to decode the lower-half of the operational code to generate a lower-half decoded operational code.

13. A data movement module according to claim 12, wherein the upper-half of the operand read pipeline stage further comprises:
a plurality of upper-half operand selection multiplexers that are designed to select particular ones of the upper-halves of the one or more split-operands and to output the selected split-operands as the upper-half of a first operand, the upper-half of a second operand, and an upper-half of a third operand; and
wherein the upper-half of the data movement instruction lookup pipeline stage, comprises:
a first flip-flop configured to receive the upper-half decoded operational code and the upper-half of the third operand;
a second flip-flop configured to receive the upper-half of the first operand, the upper-half of the second operand;
a first multiplexer configured to receive the upper-half decoded operational code;
a second multiplexer configured to receive the upper-half of the first operand, and a third multiplexer configured to receive the upper-half of the second operand; and
a first permute control module, comprising:
a first lookup table (LUT) configured to receive first inputs comprising the upper-half decoded operational code from the first multiplexer, the upper-half of the first operand, the upper-half of the second operand, and the upper-half of the third operand from the second flip-flop, and to translate the first inputs into a first set of control byte selection outputs;
a first control byte selection multiplexer configured to select, based on the upper-half decoded operational code, one of the first set of control byte selection outputs as the first set of control bytes that correspond to each byte of the upper-half of the first operand and the upper-half of the second operand; and
wherein the lower-half of the operand read pipeline stage of the data movement module, further comprises:
a plurality of lower-half operand selection multiplexers that are designed to select particular ones of the lower-halves of the one or more split-operands and to output the selected split-operands as the lower-half of the first operand, the lower-half of the second operand, and a lower-half of the third operand; and
wherein the lower-half of the data movement instruction lookup pipeline stage, comprises:
a third flip-flop configured to receive the lower-half decoded operational code and the lower-half of the third operand;
a fourth flip-flop configured to receive the lower-half of the first operand, and the lower-half of the second operand;
a fourth multiplexer configured to receive the lower-half decoded operational code;
a fifth multiplexer configured to receive the lower-half of the first operand, and
a sixth multiplexer configured to receive the lower-half of the second operand; and
a second permute control module, comprising:
a second lookup table (LUT) configured to receive second inputs comprising the lower-half decoded operational code from the fourth multiplexer, the lower-half of the first operand, the lower-half of the second operand, and the lower-half of the third operand from the fourth flip-flop, and to translate the second inputs into a second set of control byte selection outputs;
a second control byte selection multiplexer configured to select, based on the lower-half decoded operational code, one of the second set of control byte selection outputs as the second set of control bytes that correspond to each byte of the lower-half of the first operand and the lower-half of the second operand.

14. A data movement module according to claim 12, wherein the upper-half of the data movement instruction lookup pipeline stage comprises:
a first multiplexer configured to receive the upper-half decoded operational code;
a second multiplexer configured to receive the upper-half of the first operand, and a third multiplexer configured to receive the upper-half of the second operand; and
a first permute control module, comprising:
a first lookup table (LUT) configured to translate the upper-half decoded operational code into a first set of control byte selection outputs; and
a first control byte selection multiplexer configured to select, based on the upper-half decoded operational code, one of the first set of control byte selection outputs as the first set of control bytes that correspond to each byte of the upper-half of the first operand and the upper-half of the second operand; and
wherein the lower-half of the data movement instruction lookup pipeline stage comprises:
a fourth multiplexer configured to receive configured to receive the lower-half decoded operational code;
a fifth multiplexer configured to receive the lower-half of the first operand, and
a sixth multiplexer configured to receive the lower-half of the second operand; and
a second permute control module, comprising:
a second lookup table (LUT) that translates the lower-half decoded operational code into a second set of control byte selection outputs; and
a second control byte selection multiplexer configured to select, based on the lower-half decoded operational code, one of the second set of control byte selection outputs as the second set of control bytes that correspond to each byte of the lower-half of the first operand and the lower-half of the second operand.

15. A data movement module according to claim 11, wherein the byte swap pipeline stage comprises:
a byte swapper module configured to:
select, based on some of the bits of each of the first set of control bytes and the second set of control bytes, selected bytes from one or more of the upper-half of the first operand, the upper-half of the second operand, the lower-half of the first operand and the lower-half of the second operand; and
swap, based on the first set of control bytes and the second set of control bytes, one or more of the selected bytes with another one of the selected bytes to generate resultant bytes of a byte swap stage intermediate result that comprises the resultant bytes arranged in the order specified by the permute operation according to the first set of control bytes and the second set of control bytes.

16. A data movement module according to claim 15, wherein the swapping performed by the byte swap pipeline stage includes one or more of manipulating, shifting, moving, re-ordering, shuffling or scrambling one or more of the selected bytes with respect to another one of the selected bytes to generate resultant bytes of the byte swap stage intermediate result.

17. A data movement module according to claim 15, wherein the byte swapper module comprises a plurality of byte swapper sub-modules, and wherein each byte swapper sub-module, comprises:
a byte selection multiplexer that receives the upper-half of the first operand, the upper-half of the second operand, the lower-half of the first operand and the lower-half of the second operand, and a particular one of the control bytes, and selects, based on some of the bits of the particular control byte, a selected byte from one of the upper-half of the first operand, the upper-half of the second operand, the lower-half of the first operand and the lower-half of the second operand; and
a corresponding byte manipulation module coupled to the byte selection multiplexer designed to manipulate the selected byte from the byte selection multiplexer to generate manipulated versions of the selected byte.

18. A data movement module according to claim 17, wherein the corresponding byte manipulation modules comprises:
a post selection processor module that is configured to receive the selected byte that was selected by the byte selection multiplexer and manipulate bits of the selected byte to generate manipulated versions of the selected byte; and
a byte manipulation multiplexer, coupled to the post selection processor module, that is configured to select, based on other bits of the particular control byte, either the selected byte or one of the manipulated versions of the selected byte as a resultant byte.

19. A data movement module according to claim 18, wherein each post selection processor module is configured to receive the selected byte that was selected by a corresponding byte selection multiplexer of that post selection processor module and manipulate bits of the selected byte seven different ways to generate seven different manipulated versions of the selected byte, and
wherein each byte manipulation multiplexer is configured to select, based on other bits of the particular control byte, either the selected byte or one of the seven manipulated versions of the selected byte as a resultant byte.

20. A data movement module according to claim 19, wherein the byte swapper module comprises sixteen byte swapper sub-modules, and wherein the byte swapper module outputs sixteen resultant bytes together as a 128-bit byte swap stage intermediate result.

21. A data movement module according to claim 12, wherein the data movement module further comprises:
a bit swizzle pipeline stage configured to split the byte swap stage intermediate result into an upper-half of the byte swap stage intermediate result, and a lower-half of the byte swap stage intermediate result, the bit swizzle pipeline stage comprising:
an upper-half that is configured to shift bits of the upper-half of the byte swap stage intermediate result per an instruction in the upper-half of the decoded opcode to generate a bit-shifted version of the upper-half of the byte swap stage intermediate result and to select, based on the upper-half of the decoded opcode, either the upper-half of the byte swap stage intermediate result or the bit-shifted version of the upper-half of the byte swap stage intermediate result as an upper-half result, and
a lower-half that that is configured to shift bits of the lower-half of the byte swap stage intermediate result per an instruction in the lower-half of the decoded opcode to generate a bit-shifted version of the lower-half of the byte swap stage intermediate result, and to select, based on the lower-half of the decoded opcode, either the lower-half of the byte swap stage intermediate result or the bit-shifted version of the lower-half of the byte swap stage intermediate result as a lower-half result.

22. A data movement module according to claim 21, wherein the bit swizzle pipeline stage comprises:
a flip-flop that is configured to receive the byte swap stage intermediate result and to split the byte swap stage intermediate result into an upper-half of the byte swap stage intermediate result, and a lower-half of the byte swap stage intermediate result;
an upper-half bit shifter module that is configured to receive the upper-half of the decoded opcode and the upper-half of the byte swap stage intermediate result, and to shift bits of the upper-half of the byte swap stage intermediate result per an instruction in the upper-half of the decoded opcode to generate a bit-shifted version of the upper-half of the byte swap stage intermediate result;
an upper-half multiplexer that is configured to select, based on the upper-half of the decoded opcode, either the upper-half of the byte swap stage intermediate result or the bit-shifted version of the upper-half of the byte swap stage intermediate result as an upper-half result;
a lower-half bit shifter module that is configured to receive the lower-half of the decoded opcode and the lower-half of the byte swap stage intermediate result, and to shift bits of the lower-half of the byte swap stage intermediate result per an instruction in the lower-half of the decoded opcode to generate a bit-shifted version of the lower-half of the byte swap stage intermediate result; and
a lower-half multiplexer that is configured to select, based on the lower-half of the decoded opcode, either the lower-half of the byte swap stage intermediate result or the bit-shifted version of the lower-half of the byte swap stage intermediate result as a lower-half result.

23. A data movement module according to claim 22, wherein the upper-half bit shifter module comprises:
eight bit shifter sub-modules that are each eight bits wide, wherein each bit shifter sub-module is configured to shift or rotate bits in any particular byte of the upper-half of the byte swap stage intermediate result by up to a maximum of 7 bit positions on byte, word, double word or quad word boundaries depending on information specified in the upper-half of the decoded opcode to generate the bit-shifted version of the upper-half of the byte swap stage intermediate result, and
wherein the lower-half bit shifter module comprises:
eight bit shifter sub-modules that are each eight bits wide, wherein each bit shifter sub-module is configured to shift or rotate bits in any particular byte of the lower-half of the byte swap stage intermediate result by up to a maximum of 7 bit positions on byte, word, double word or quad word boundaries depending on information specified in the lower-half of the decoded opcode to generate the bit-shifted version of the lower-half of the byte swap stage intermediate result.

24. A processor comprising a data movement module configured to execute a data manipulation instruction to perform data manipulation with respect to first and second operands each of which are split into an upper-half and a lower-half, the data movement module comprising:
a first pipeline stage configured to:
receive an upper-half of an operational code and to generate a first set of control bytes that correspond to the data manipulation instruction that is to be performed with respect to each byte of an upper-half of a first operand and an upper-half of the second operand, and
receive a lower-half of the operational code and to generate a second set of control bytes that correspond to the data manipulation instruction that is to be performed with respect to each byte of a lower-half of the first operand and a lower-half of the second operand;
a second pipeline stage configured to:
based on the first set of control bytes and the second set of control bytes, select selected bytes from one or more of the upper-half of the first operand, the upper-half of the second operand, the lower-half of the first operand and the lower-half of the second operand, and
swap one or more of the selected bytes with another one of the selected bytes to generate resultant bytes of a byte swap stage intermediate result that comprises the resultant bytes arranged in the order specified by the permute operation; and
a third pipeline stage configured to:
split the byte swap stage intermediate result into an upper-half of the byte swap stage intermediate result, and a lower-half of the byte swap stage intermediate result,
shift bits of the upper-half of the byte swap stage intermediate result per an instruction in the upper-half of the decoded opcode to generate a bit-shifted version of the upper-half of the byte swap stage intermediate result,
shift bits of the lower-half of the byte swap stage intermediate result per an instruction in the lower-half of the decoded opcode to generate a bit-shifted version of the lower-half of the byte swap stage intermediate result,
select, based on the upper-half of the decoded opcode, either the upper-half of the byte swap stage intermediate result or the bit-shifted version of the upper-half of the byte swap stage intermediate result as an upper-half result; and
select, based on the lower-half of the decoded opcode, either the lower-half of the byte swap stage intermediate result or the bit-shifted version of the lower-half of the byte swap stage intermediate result as a lower-half result.
